(19) United States
(12) Patent Application Publication
(10) Pub. No.: US 2011/0205227 A1
(43) Pub. Date: Aug. 25, 2011

(54) Method Of Using A Storage Switch

(76) Inventors: Mani Fischer, Haifa (IL); Doron Shaked, Tivon (IL)

(21) Appl. No.: 13/126,831

(22) PCT Filed: Oct. 31, 2008
(86) PCT No.: PCT/US08/12350

§ 371 Date: Apr. 29, 2011

(51) Int. Cl. G06T 15/00

(52) U.S. Cl. 345/419; 348/E13.001

(57) ABSTRACT

Various embodiments of the present invention are directed to methods and systems for processing signals, particularly signals encoding two-dimensional images, such as photographs, video frames, graphics, and other visually displayed information. Rather than attempting 3D-boosting by applying a global contrast enhancement method, method and system embodiments of the present invention generate a soft-segmented image, portions of which are effectively locally contrast enhanced and portions of which, having excepted region types, are not locally contrast enhanced, to produce an output image which is selectively 3D-boosted.

### TECHNICAL FIELD

The present invention is related to signal processing and, in particular, to a computationally efficient and effective method and system for enhancing image signals to alter the depth perceived by viewers of two-dimensional images rendered from the image signals.

### BACKGROUND OF THE INVENTION

Computational methods for signal processing provide foundation technologies for many different types of systems and services, including systems and services related to recording, transmission, and rendering of signals that encode images and graphics, including photographic images, video signals, and other such signals. Over the years, many different types of image-enhancement functionalities have been devised and implemented, including computational routines and/or logic circuits that implement sharpening, contrast enhancement, denoising, and other image-enhancement functionalities.

Contrast enhancement is a general term to describe a number of different types of enhancements, including global enhancements such as brightening, darkening, histogram stretching or equalization, gamma correction, and others, as well as local enhancements, including shadow lighting, adaptive lighting, highlight enhancement, and others. Many contrast enhancement algorithm are successful in producing certain of the above enhancements, but are not successful in achieving other types of enhancements. In particular, significant research and development efforts have been directed to developing techniques for enhancing image signals to increase appreciation, by viewers, of two-dimensional images rendered from the image signals. Unfortunately, contrast enhancement techniques often result in uneven effects, and may lead to introduction of perceptible anomalies and artifacts, as well as provide an unwanted increase in depth-perception effects in certain portions of an image. For these reasons, designers, developers, vendors, and users of image-enhancement software, image-enhancement-related logic circuits, image-enhancement-related systems and devices, and a large number of different types of devices that include image-enhancement functionality continue to devise and develop improved computational methods for well-known and new contrast enhancements as well as systems that provide more natural, computationally efficient contrast enhancement of two-dimensional images and other signals, including signals that encode video frames, graphics, and other visually displayed information.

### SUMMARY OF THE INVENTION

Various embodiments of the present invention are directed to methods and systems for processing signals, particularly signals encoding two-dimensional images, such as photographs, video frames, graphics, and other visually displayed information. Certain method and system embodiments of the present invention generate a soft-segmented image, portions of which are effectively locally contrast enhanced and portions of which, having excepted region types, are not locally contrast enhanced, to produce an output image which is selectively 3D-boosted.

### BRIEF DESCRIPTION OF THE DRAWINGS

FIG. 1 illustrates a two-dimensional image signal.

FIG. 2 shows the two-dimensional image of FIG. 1 with numerical pixel values.

FIG. 3 illustrates addition of two images A and B.

FIGS. 4A-E illustrate a convolution operation.

FIG. 5 illustrates one type of scaling operation, referred to as “downscaling.”

FIG. 6 illustrates a lookup-table operation.

FIG. 7A illustrates one simple method of contrast enhancement.

FIG. 7B shows a histogram and cumulative histogram for a tiny, hypothetical image containing 56 pixels, each having one of 32 grayscale values.

FIG. 7C shows the histogram and cumulative histogram for the image, discussed with reference to FIG. 7B, following contrast enhancement by multiplying the pixels of the original image by the constant factor 1.2.

FIGS. 8A-B illustrate, at a high level, generation of the photographic mask and temporary image by the USSIP and use of the photographic mask and temporary image to generate a locally and globally contrast-enhanced, sharpened, and denoised output image.

FIG. 9 illustrates a generalized, second part of comprehensive image enhancement in the USSIP.

FIG. 10 illustrates a modified approach to comprehensive image enhancement that represents an alternative implementation of the USSIP.

FIG. 11 shows a simplified version of the image-enhancement method shown in FIG. 10.

FIGS. 12-15 illustrate computation of intermediate low-pass images of the low-pass pyramid fᵢ.

FIGS. 16A-D illustrate computation of individual pixels of a band-pass intermediate image lₛ from neighboring pixels in the low-pass intermediate images fₛ and fₛ₊₁.

FIG. 17 illustrates, using similar illustrations as used in FIGS. 16A-D, computation of pixels in rₛ for four different coordinate-parity cases.

FIG. 18 illustrates, using similar illustration conventions to those used in FIGS. 16A-D and FIG. 17, computation of pixels in tₛ for each of the coordinate-parity cases.

FIG. 19 shows an example histogram and cumulative histogram.

FIG. 20 shows a hypothetical normalized cumulative histogram for an example image.

FIG. 21 is a simple flow-control diagram that illustrates the general concept of 3D boosting.

FIG. 22 is a more detailed version of FIG. 21.

FIG. 23 illustrates a second approach to 3D boosting.

FIG. 24 is a control-flow diagram that illustrates a third approach to 3D boosting.

FIG. 25 illustrates the approach to 3D boosting using a schematic-like technique.

FIG. 26 is a block diagram of an embodiment of an image enhancement system.

FIG. 27 is a flow diagram of an embodiment of an image enhancement method.

FIG. 28 shows an example of an input image that contains two human faces.

FIG. 29 is a block diagram of an embodiment of the face-map module shown in FIG. 26.

FIG. 30 is a block diagram of an embodiment of a single classification stage in an implementation of the face-map module shown in FIG. 29 that is designed to evaluate candidate face patches in an image.

FIG. 31 is a graphical representation of an example of a face map generated by the face-map module of FIG. 29 from the input image shown in FIG. 28.

FIGS. 32A-C illustrate two of various different types of ways in which a face map or skin map can be used to generate decision maps that indicate whether or not to apply 3D boosting or 3D busting.

FIG. 33 shows scaling of a binary map.

FIG. 34 shows a control-flow diagram for an enhanced 3D-boosting and 3D-busting method that represents one embodiment of the present invention.

FIG. 35 shows a control-flow diagram for one embodiment of the present invention, which parallels the control-flow diagram provided in FIG. 22.

FIG. 36 shows a control-flow diagram for a second embedment of the present invention, which parallels the control-flow diagram provided in FIG. 23.

FIG. 37 shows a control-flow diagram for a third embodiment of the present invention, which parallels the control-flow diagram provided in FIG. 24.

### DETAILED DESCRIPTION OF THE INVENTION

Embodiments of the present invention are directed to computationally efficient and effective methods and systems for enhancing image signals to increase the depth perceived by viewers of two-dimensional images rendered from the image signals, without producing unwanted depth-perception-related effects in certain portions of an image, including human-face sub-images. In the following discussion, image signals and various mathematical operations-carried out on image signals are first discussed, in a number of short subsections. Then, a general method for 3D boosting is discussed, after which a method for identifying human-face-related portions of an image is described. Finally, embodiments of the present invention are provided in a final subsection.

### Images

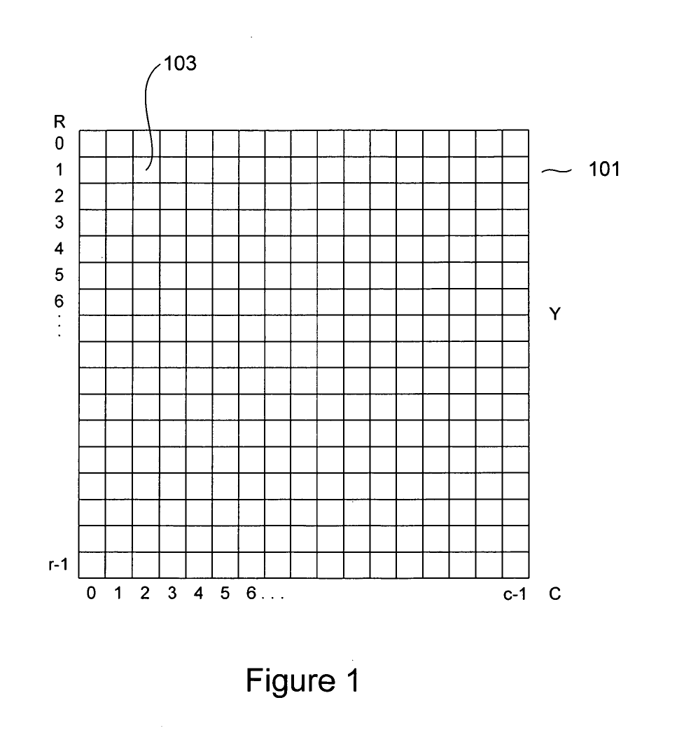

FIG. 1 illustrates a two-dimensional image signal. As shown in FIG. 1, the two-dimensional image signal can be considered to be a two-dimensional matrix 101 containing R rows, with indices 0, 1, . . . , r−1, and C columns, with indices 0, 1, . . . , c−1. In general, a single upper-case letter, such as the letter “Y,” is used to present an entire image. Each element, or cell, within the two-dimensional image Y shown in FIG. 1 is referred to as a “pixel” and is referred to by a pair or coordinates, one specifying a row and the other specifying a column in which the pixel is contained. For example, cell 103 in image Y is represented as Y(1,2).

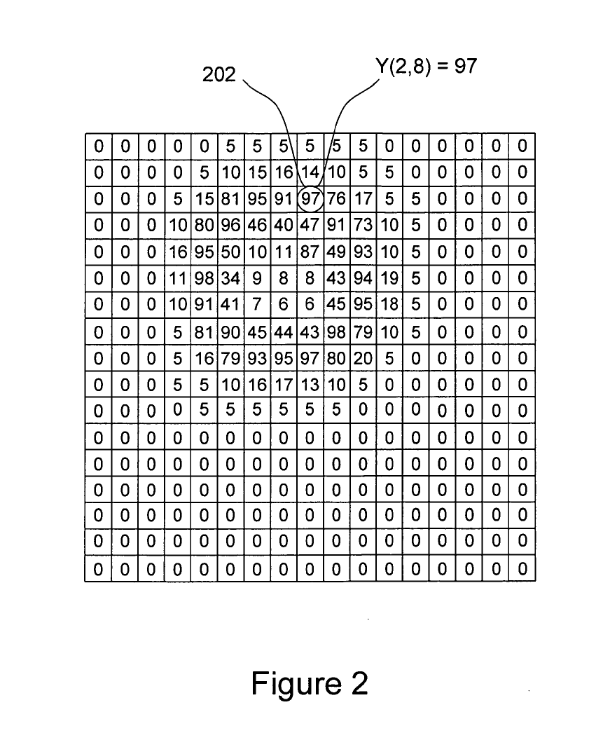

FIG. 2 shows the two-dimensional image of FIG. 1 with numerical pixel values. In FIG. 2, each pixel is associated with a numerical value. For example, the pixel Y(2,8) 202 is shown, in FIG. 2, having the value “97.” In certain cases, particularly black-and-white photographs, each pixel may be associated with a single, grayscale value, often ranging from 0, representing black, to 255, representing white. For color photographs, each pixel may be associated with multiple numeric values, such as a luminance value and two chrominance values, or, alternatively, three RBG values. In cases in which pixels are associated with more than one value, image-enhancement techniques may be applied separately to partial images, each representing a set of one type of pixel value selected from each pixel, image-enhancement techniques may be applied to a computed, single-valued-pixel image in which a computed value is generated for each pixel by a mathematical operation on the multiple values associated with the pixel in the original image, or image-enhancement techniques may be primarily applied to only the luminance partial image. In the following discussion, images are considered to be single-valued, as, for example, grayscale values associated with pixels in a black-and-white photograph. However, the disclosed methods of the present invention may be straightforwardly applied to images and signals with multi-valued pixels, either by separately sharpening one or more partial images or by combining the multiple values associated with each pixel mathematically to compute a single value associated with each pixel, and sharpening the set of computed values. It should be noted that, although images are considered to be two-dimensional arrays of pixel values, images may be stored and transmitted as sequential lists of numeric values, as compressed sequences of values, or in other ways. The following discussion assumes that, however images are stored and transmitted, the images can be thought of as two-dimensional matrices of pixel values that can be transformed by various types of operations on two-dimensional matrices.

In the following subsections, a number of different types of operations carried out on two-dimensional images are described. These operations range from simple numeric operations, including addition and subtraction, to convolution, scaling, and robust filtering. Following a description of each of the different types of operations, in separate subsections, a final subsection discusses embodiments of the present invention implemented using these operations.

### Image Subtraction and Addition

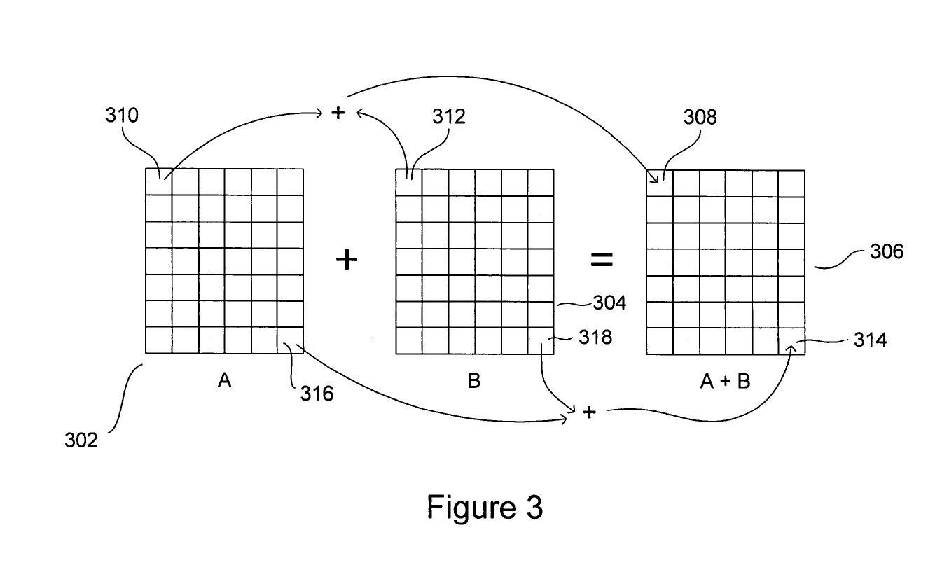

FIG. 3 illustrates addition of two images A and B. As shown in FIG. 3, addition of image A 302 and image B 304 produces a result image A+B 306. Addition of images is carried out, as indicated in FIG. 3, by separate addition of each pair of corresponding pixel values of the addend images. For example, as shown in FIG. 3, pixel value 308 of the result image 306 is computed by adding the corresponding pixel values 310 and 312 of addend images A and B. Similarly, the pixel value 314 in the resultant image 306 is computed by adding the corresponding pixel values 316 and 318 of the addend images A and B. Similar to addition of images, an image B can be subtracted from an image A to produce a resultant image A−B. For subtraction, each pixel value of B is subtracted from the corresponding pixel value of A to produce the corresponding pixel value of A−B. Images may also be pixel-by-pixel multiplied and divided.

### Convolution

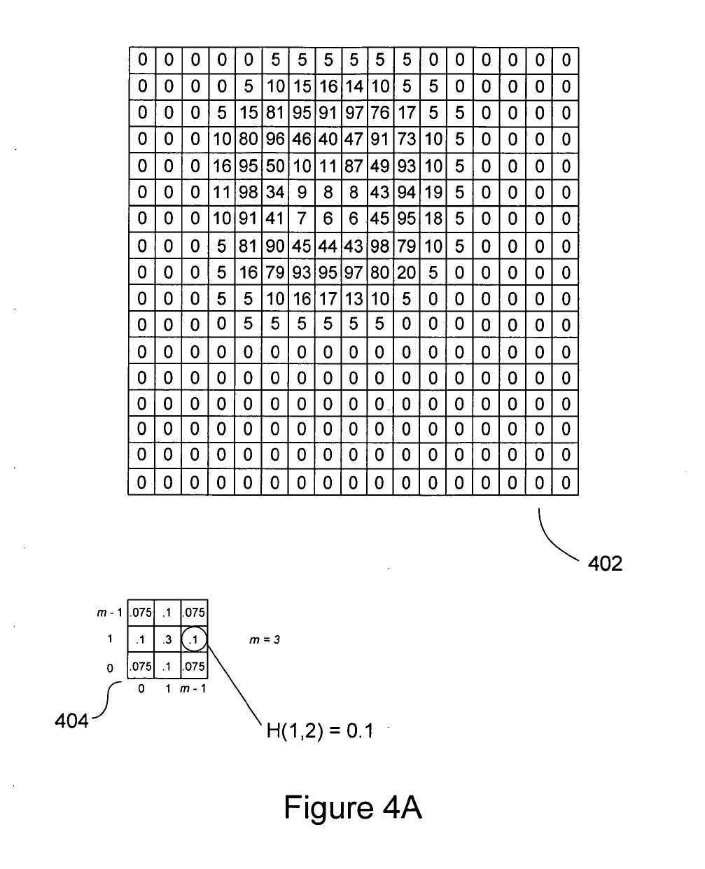

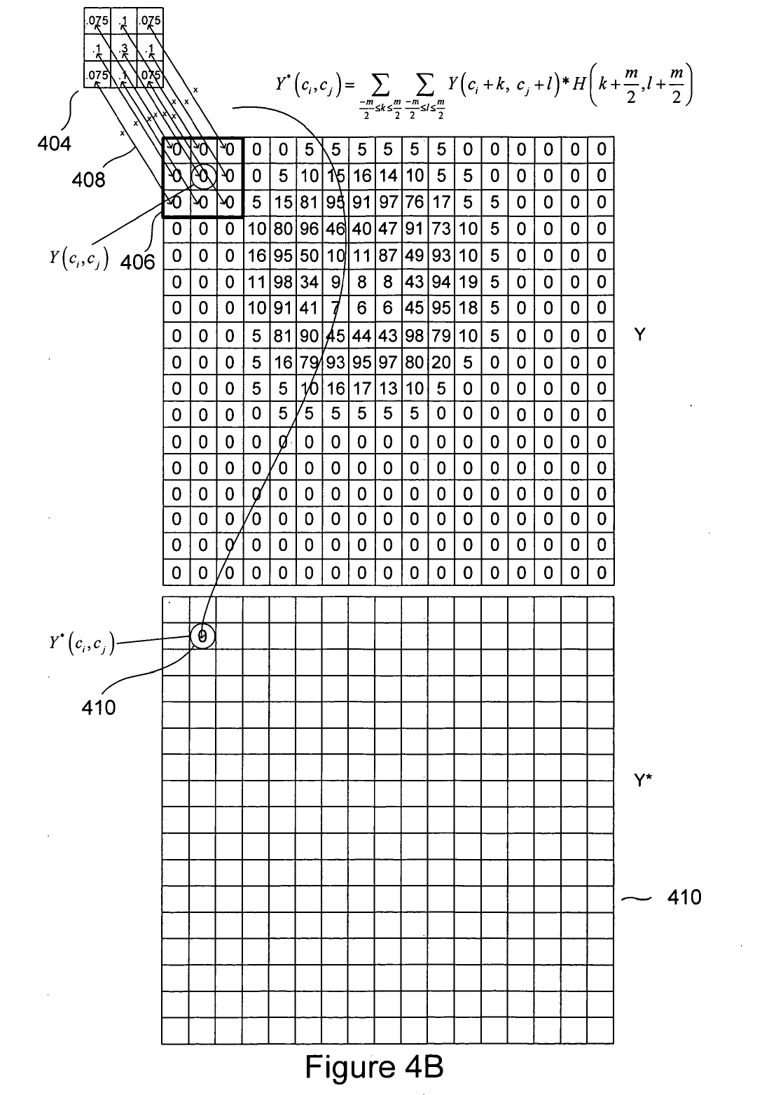

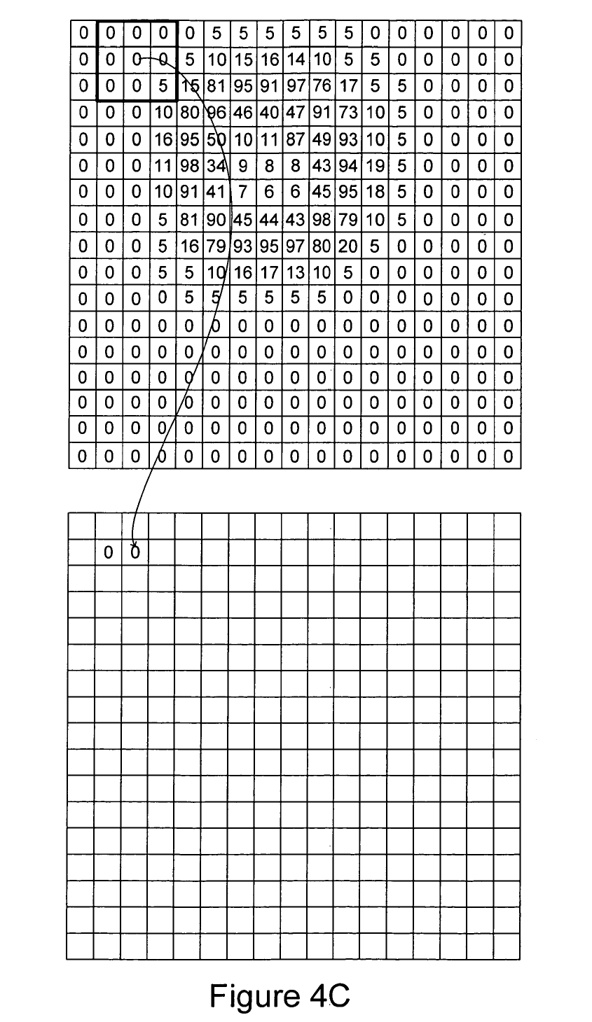

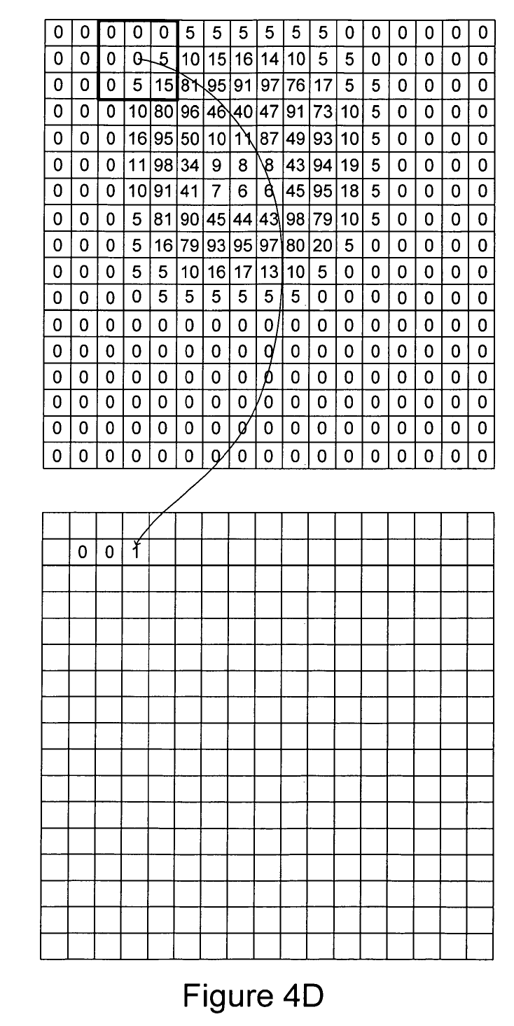

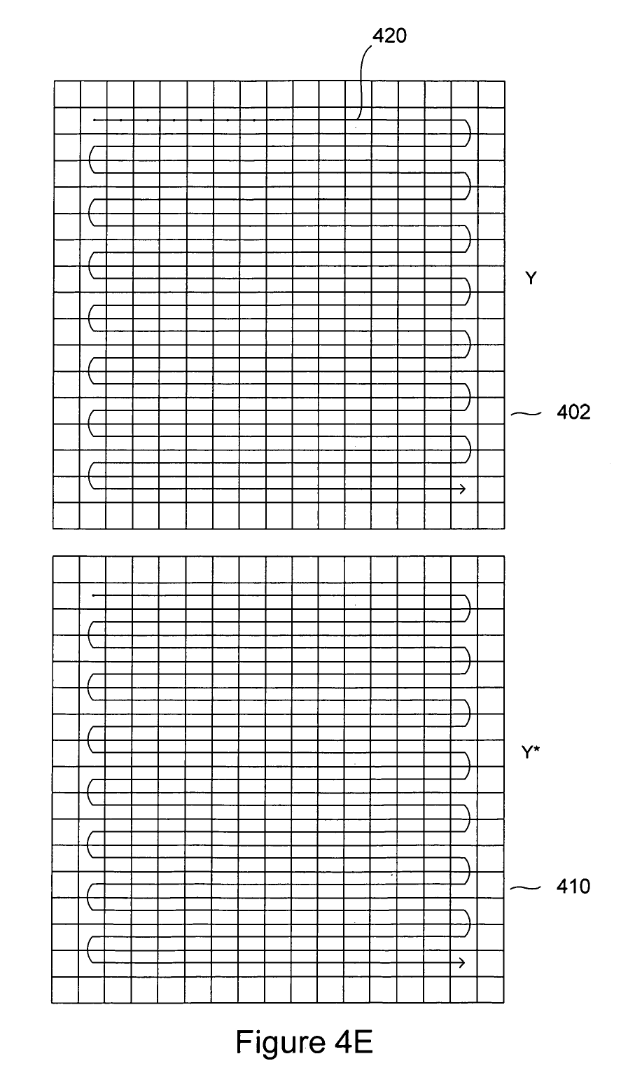

A second operation carried out on two-dimensional images is referred to as “convolution.” FIGS. 4A-E illustrate a convolution operation. Convolution involves, in general, an image 402 and a mask 404. The mask 404 is normally a small, two-dimensional array containing numeric values, as shown in FIG. 4A, but may alternatively be a second image. Either an image or a mask may have a different number of rows than columns, but, for convenience, the example images and masks used in the following discussion are generally shown as square, with equal numbers of rows and columns. The image Y 402 in FIG. 4A has 17 rows and columns, while the mask 404 H has three rows and columns.

FIG. 4B illustrates computation of the first cell value, or pixel value, of the image Y* that is the result of convolution of image Y with mask H, expressed as:

Y*=Y [symbol] H

As shown in FIG. 4B, the mask H 404 is essentially overlaid with a region of corresponding size and shape 406 of the image centered at image pixel Y(1,1). Then, each value in the region of the image 406 is multiplied by the corresponding mask value, as shown by the nine arrows, such as arrow 408, in FIG. 4B. The value for the corresponding pixel Y*(1,1) 410 is generated as the sum of the products of the nine multiplications. In the general case, Y*(cᵢ,cⱼ) is computed as follows:

$${Y}^{*} ( {c}_{i} , {c}_{j} ) = {\sum }_{\frac{- m}{2} \leq k \leq \frac{m}{2}} {\sum }_{\frac{- m}{2} \leq l \leq \frac{m}{2}} Y ( {c}_{i} + k , {c}_{j} + l ) ⋆ H ( k + \frac{m}{2} , l + \frac{m}{2} )$$

where m is the size of each dimension of H, and k and l have only integer values within the ranges

$$\frac{- m}{2} \leq k \leq \frac{m}{2} and \frac{- m}{2} \leq l \leq \frac{m}{2} and k + \frac{m}{2} and l + \frac{m}{2}$$

also take on only integer values. FIGS. 4C and 4D illustrate computation of the second and third values of the resultant image Y*. Note that, because the mask H is a 3×3 matrix, the mask cannot be properly overlaid with image pixels along the border of image Y. In certain cases, special border masks may be used on boundary pixels, such as, for example, 2×3 masks for interior, horizontal boundary regions. In other cases, the boundary pixel values are simply transferred to the resultant image, without a mask-based transformation. In still other cases, the boundary pixels are omitted from the resultant image, so that the resultant image has fewer rows and columns than the original image. Details of treatment of boundary regions are not further discussed in the current application. It is assumed that any of the above-mentioned techniques for handling boundary pixels, or other appropriate techniques, may be applied to handle boundary pixels.

FIG. 4E illustrates a path of application of the mask H to image Y during convolution of Y×H to produce image Y. In FIG. 4E, the path is represented by the curved arrow 420 and shows the series of successive pixels on which the mask is centered in order to generate corresponding values for the resultant image Y* 410. In alternative approaches, a different ordering of individual mask-based operations may be employed. However, in all cases, a single mask-based operation, such as that shown in FIG. 4B, is applied to each non-boundary pixel of image Y in order to produce a corresponding value for the resultant image Y*.

### Scaling

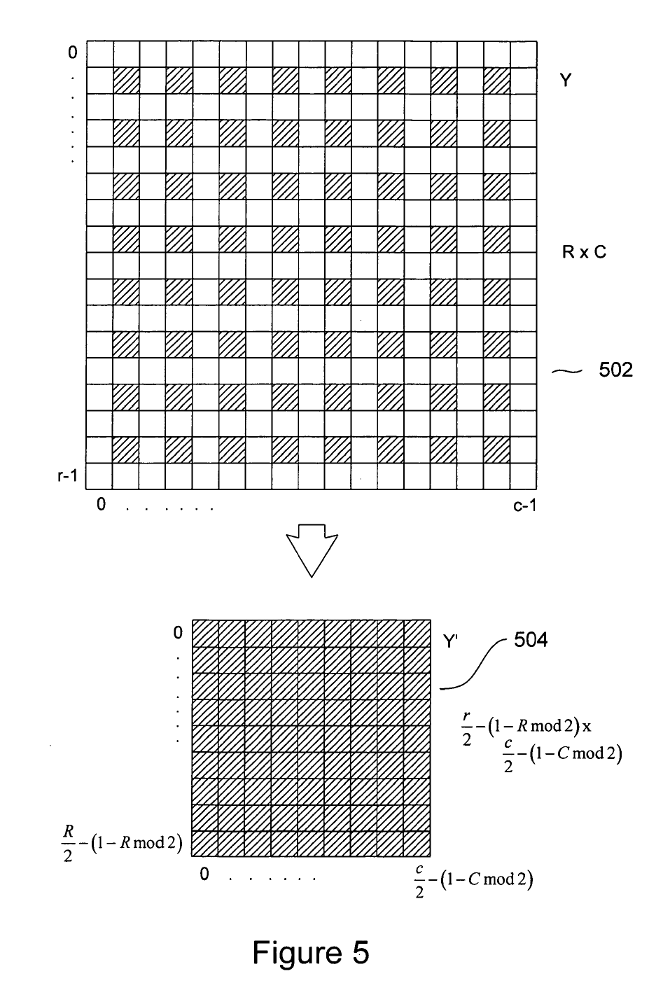

FIG. 5 illustrates one type of scaling operation, referred to as “down scaling.” As shown in FIG. 5, a first, original image Y 502 may be downscaled to produce a smaller, resultant image Y′ 504. In one approach to downscaling, every other pixel value, shown in original image Y in FIG. 5 as crosshatched pixels, is selected and combined together with the same respective positions in order to form the smaller, resultant image Y′ 504. As shown in FIG. 5, when the original image Y is a R×C matrix, then the downscaled image Y′ is an

$$[ \frac{R}{2} - ( 1 - R mod 2 ) ] \times [ \frac{C}{2} - ( 1 - C mod 2 ) ]$$

image. The downscaling shown in FIG. 5 decreases each dimension of the original two-dimensional matrix by an approximate factor of ½, thereby creating a resultant, downsized image Y′ having ¼ of the number of pixels as the original image Y. The reverse operation, in which a smaller image is expanded to produce a larger image, is referred to as upscaling. In the reverse operation, values need to be supplied for ¾ of the pixels in the resultant, larger image that are not specified by corresponding values in the smaller image. Various methods can be used to generate these values, including computing an average of neighboring pixel values, or by other techniques. In FIG. 5, the illustrated downscaling is a ½×½ downscaling. In general, images can be downscaled by arbitrary factors, but, for convenience, the downscaling factors generally select, from the input image, evenly spaced pixels with respect to each dimension, without leaving larger or unequally-sized boundary regions. Images may also be downscaled and upscaled by various non-linear operations, in alternative types of downscaling and upscaling techniques.

### Lookup-Table Operations

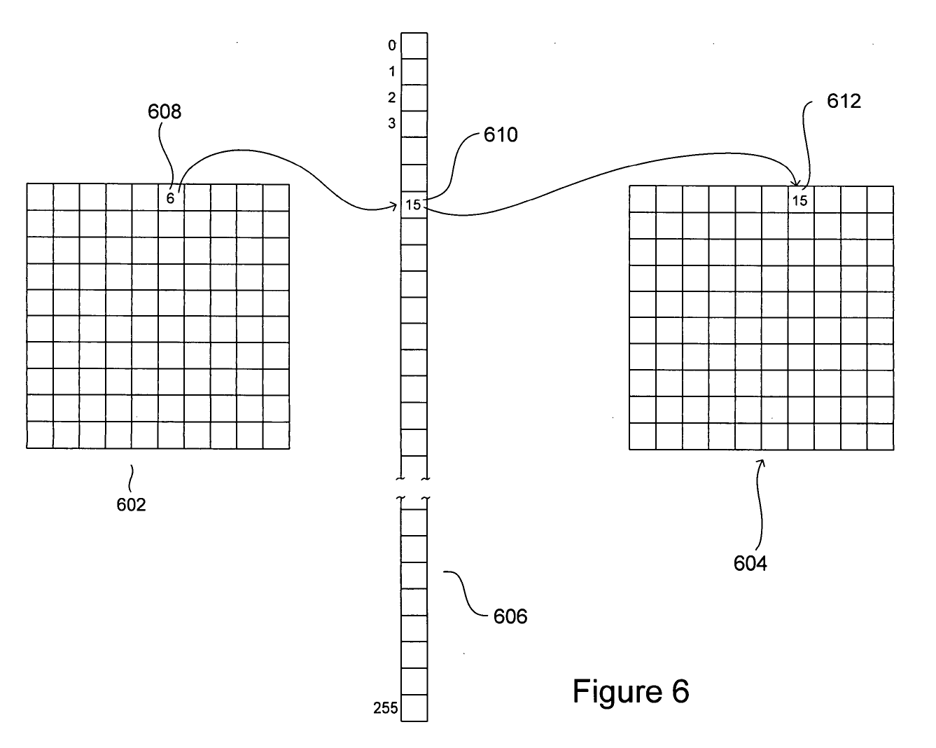

FIG. 6 illustrates a lookup-table operation. A lookup-table operation is essentially application of any function that can be expressed or approximated as a set of discrete values to an image to produce a transformed image. FIG. 6 shows a first image 602 transformed by a lookup-table operation to produce a second, transformed image 604. In the lookup-table operation illustrated in FIG. 6, the lookup table 606 is a set of 256 values that together represent a function that transforms any grayscale or luminance value in the original image 602 to a corresponding, transformed grayscale or luminance value in the transformed image 604. In general, a luminance or grayscale value, such as the value “6” 608 in the original image 602, is used as an index into the lookup table, and the contents of the lookup table indexed by that value are then used as the corresponding transformed value for the transformed image. As shown in FIG. 6, the original-image grayscale or luminance value “6” indexes the seventh element 610 of the lookup table that contains the value “15.” The value “15” is then inserted into the pixel position 612 of the transformed image 604 corresponding to the position of the pixel of the original image from which the index value is extracted. In a lookup-table operation, each luminance or grayscale value in the original image is transformed, via the lookup table, to a transformed value inserted into a corresponding position of the transformed image. Thus, a lookup-table operation is a pixel-by-pixel operation. In certain cases, two-dimensional or higher-dimensional lookup tables may be employed, when pixels are associated with two or more values, or when two or more pixel values are used for each pixel-value-generation operation. For example, a lookup-table operation may be used to transform a multi-value-pixel image to a single-value-pixel image. Any of a large number of different functions can be modeled as lookup-table operations. For example, any function that can be applied to the possible values in the original image to produce transformed values can be modeled as a lookup-table operation by applying the function to the possible values to generate corresponding transformed values and including the transformed values in a lookup table used to implement the lookup-table operation.

3D Boosting

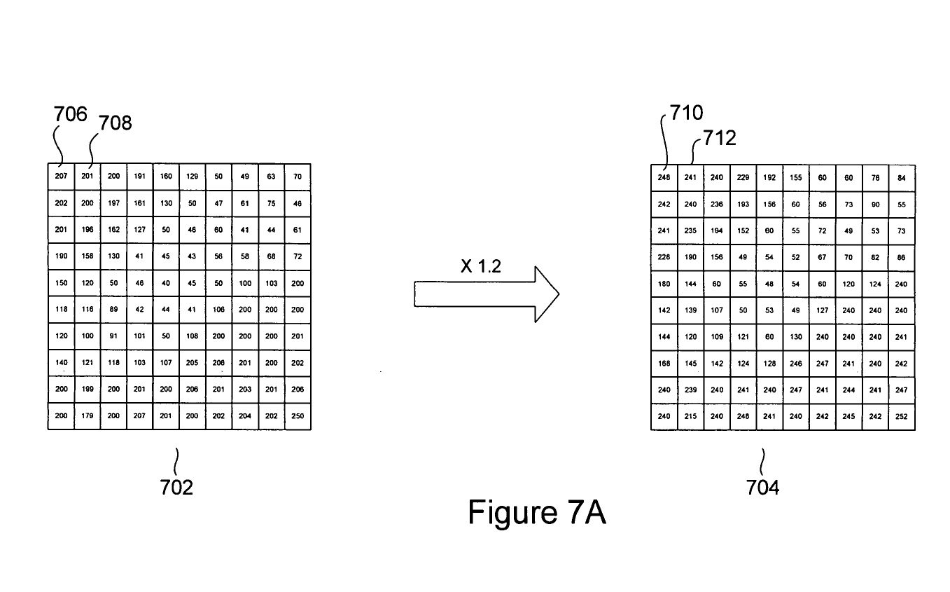

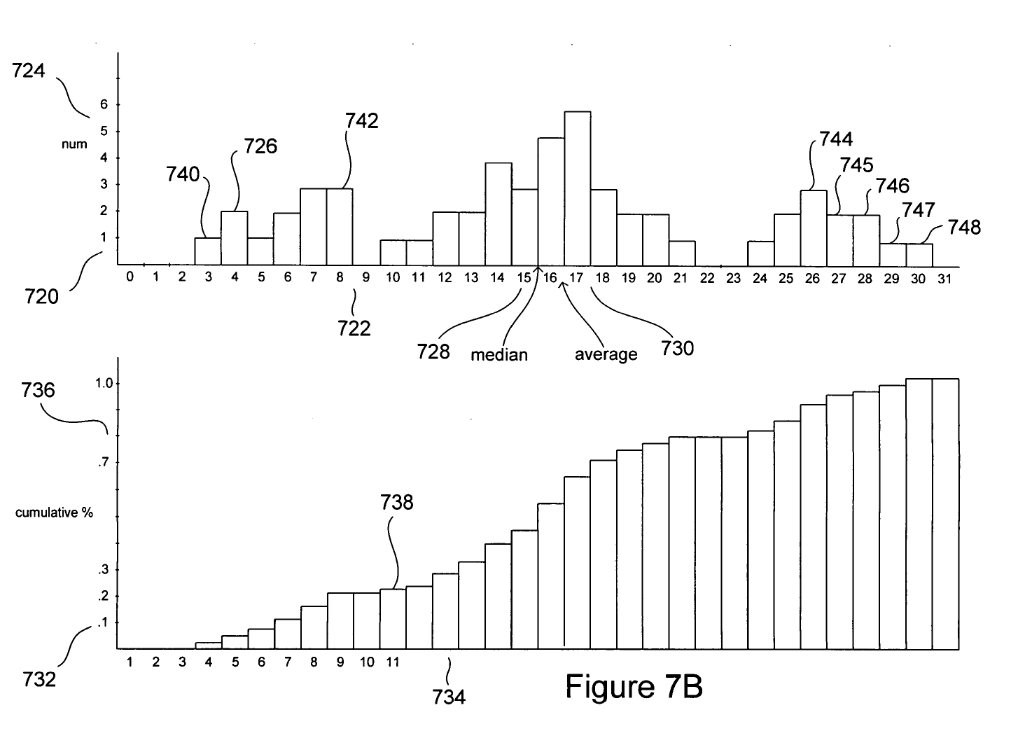

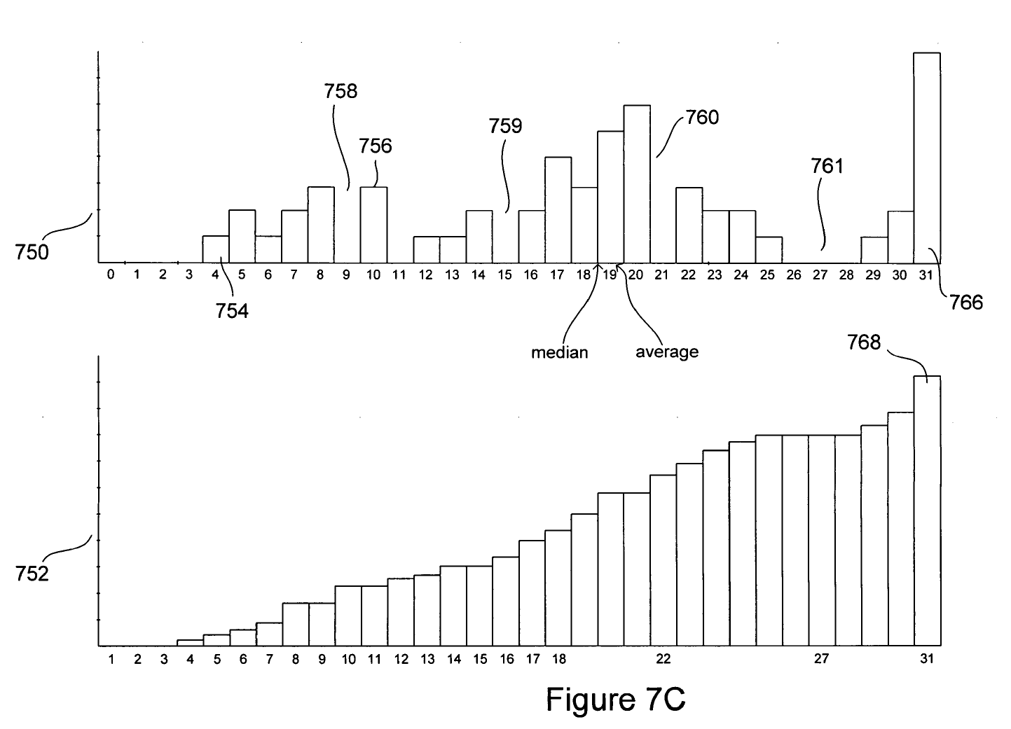

3D-boosting is accomplished by enhancing contrast within an image, such that differences between shaded and illuminated objects and portions of objects within a two-dimensional image are made more perceptible and visually distinguishable by a viewer. FIG. 7A illustrates one simple method of contrast enhancement. In FIG. 7A, a small original image 702 is contrast enhanced to produce a resulting contrast-enhanced image 704 by multiplying each grayscale or luminance value within the original image by a constant, in the case of FIG. 7A, the numerical value 1.2. By multiplying the luminance or grayscale values of an original image by a constant greater than 1.0, the differences, in magnitude, in grayscale or luminance value between adjacent pixels is magnified. For example, consider, in FIG. 7A, the first two grayscale values 706 and 708 of the original image 702. In the original image, the difference between these two values is 6. Following the transformation to a contrast-enhanced image 704, the difference between corresponding grayscale values 710 and 712 is 7.

Unfortunately, simple global-contrast-enhancement techniques do not provide for a desired, natural 3D-boosting, but instead may introduce distortion and artifacts into an image. FIG. 7B shows a histogram and cumulative-distribution histogram for a tiny, hypothetical image containing 56 pixels, each having one of 32 grayscale values. The histogram 720 shows, with bar-like columns, the number of pixels having each of the possible 32 grayscale values. The 32 grayscale values are plotted along the horizontal axis 722, and the number of pixels having each value is plotted along the vertical axis 724. Thus, for example, two pixels in the image have the grayscale value “4,” as indicated by column 726 in the histogram. The median grayscale value 728 can be computed as falling between grayscale values 15 and 16, and the average grayscale value 730 for the image can be computed as 16. The cumulative-distribution histogram 732 shows the fraction of pixels having each grayscale value and all smaller grayscale values. The grayscale values are again plotted along the horizontal axis 734, and the fractions of pixels in the image having particular grayscale values or any grayscale value smaller than the particular grayscale values is plotted with respect to the vertical axis 736. For example, column 738 in the cumulative-distribution histogram indicates that 25 percent of the pixels in the image have grayscale values equal to, or less than, 11.

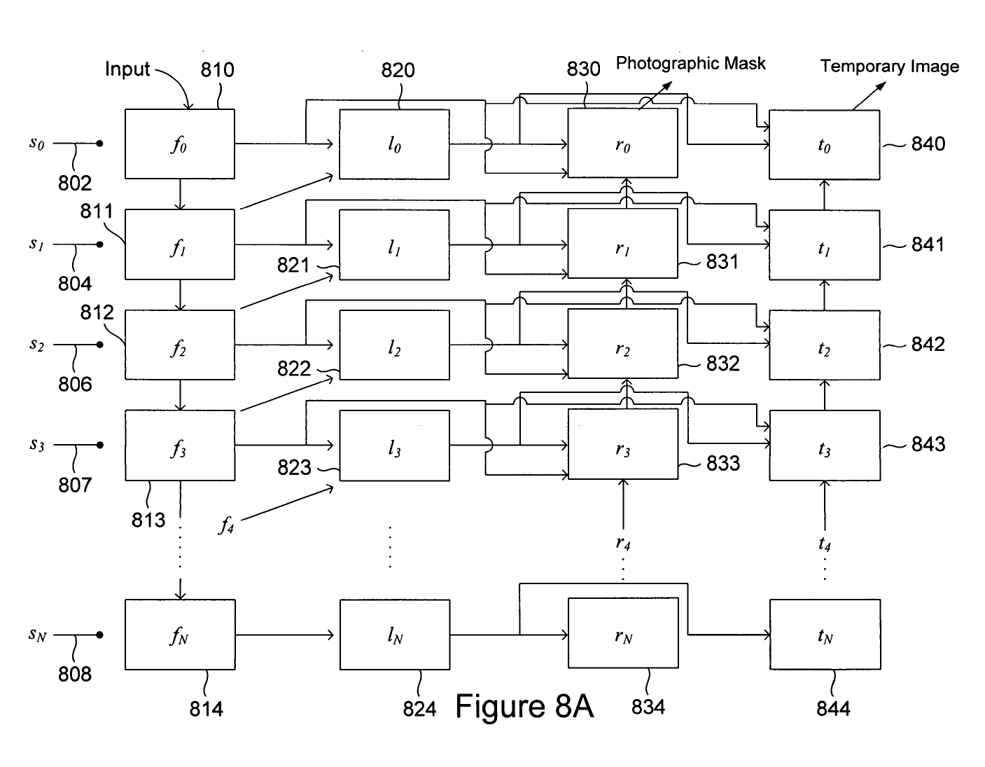

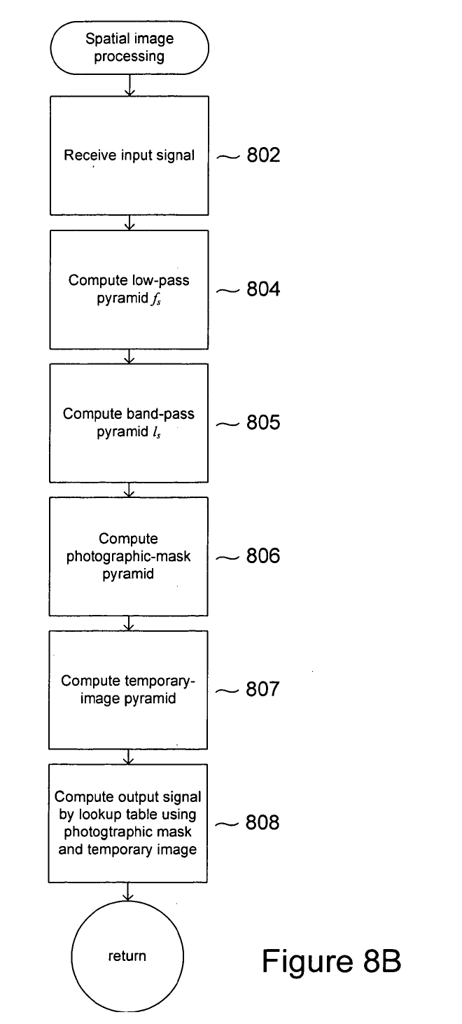

FIG. 7C shows the histogram and cumulative histogram for the image, discussed with reference to FIG. 8, following contrast enhancement by multiplying the pixels of the original image by the constant factor 1.2. By comparing the histogram 750 for the contrast-enhanced image and the cumulative-distribution histogram 752 for the contrast-enhanced image with respect to the histogram and cumulative histogram for the original image (720 and 732 in FIG. 7B), various problems associated with global contrast enhancement can be seen. In general, the contrast-enhancement technique has shifted the bars of the histogram for the globally enhanced image rightward with respect to the columns in the histogram for the original image. For example, column 754 in the histogram for the contrast-enhanced image corresponds to column 740 in the histogram for the original image. Column 754 appears at grayscale-magnitude “4,” while column 740 appears at grayscale magnitude “3.” However, the rightward shifting is not uniform. While the first five columns have been shifted rightward by one position, or grayscale value, in the histogram for the globally enhanced image, the sixth column 756 has been shifted rightward by two positions with respect to the corresponding column 742 in the histogram for the original image. Thus, every sixth column in the histogram for the globally enhanced image is shifted rightward by an additional position, leaving blank columns at every sixth position 758-761. These blank columns were not present in the histogram for the original image. Thus, the shape of the original histogram has been somewhat distorted by the global-enhancement technique of multiplying grayscale values by a constant greater than 1.0. While this distortion is quite inconsequential, in the case illustrated in FIGS. 7B-C, more serious and perceptible distortions may arise by non-uniform changes made to pixel values as a result of a global enhancement technique.

In addition, consider the final five columns of the histogram for the original image 744-748. In the histogram for the globally enhanced image, all five of these columns have been compressed into a single column 766. Note also that the shape of the cumulative distribution histogram 752 for the globally enhanced image is different from that for the original image (732 in FIG. 7B). The cumulative-distribution histogram is rightward shifted, as with the histogram, but there is now a relatively sharp discontinuity with respect to the final peak 768 not present in the cumulative-distribution histogram for the original image 732. This effect is referred to as “saturation.” Large-magnitude values may be compressed into a single, largest-magnitude value by constant-multiplication amplification, and small-magnitude values may be compressed into a single, low-magnitude value by constant-multiplication compression.

A much greater problem is that, in general, when one portion of an image is amplified, some other portion of the image must be correspondingly compressed in order to avoid an overall brightness change. In other words, if a portion of the image is amplified by multiplying the pixel values in that portion of the image by a constant greater than 1.0, then another portion of the image needs to be compressed by multiplying the pixel values in that portion of the image by a constant less than 1.0. Such amplification and compression in different regions of the image may lead to quite perceptible artifacts and distortions.

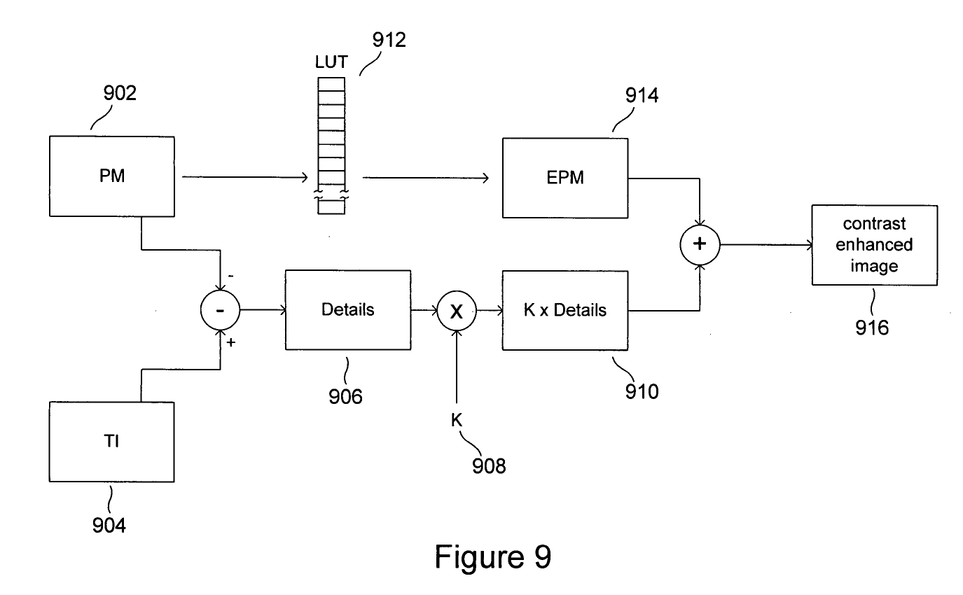

The changes in the histogram and cumulative-distribution histogram for the hypothetical, tiny figure, discussed with reference to FIGS. 8 and 9, are relatively small in comparison with the changes that may arise in an actual image. Problems associated with the global-enhancement technique can be summarized as follows. First, a function applied to pixel values of an image may lead to non-uniform changes in relative pixel values within a region of the image. Saturation may also occur, because the grayscale or illumination range is finite, and cannot be expanded at the extreme values. A more serious problem is that, when one portion of an image, or range of grayscale values, is enhanced, or amplified, then another portion of the image, or range of grayscale values, needs to be compressed in order to avoid changing the overall brightness of the image.

### Unified Scheme for Spatial Image Processing

Recently, a multi-scale approach to image processing has been developed. In this subsection, the unified scheme for spatial image processing (“USSIP”) is described, as background for subsequent discussion of the present invention.

The USSIP is a unified approach to comprehensive image enhancement in which a number of different facets of image enhancement are carried out concurrently through a multi-scale image decomposition that produces a number of series of intermediate images and reconstruction of the intermediate images to generate a final, enhanced image for output. Two intermediate images at highest-resolution scale, used in subsequent processing, are computed by a first portion of the method that includes computation of a number of different intermediate images at each of the number of different scales. The two intermediate images include a photographic mask and a temporary image. The photographic mask is a transformation of the luminance, lightness, grayscale, or other values of the input image in which details with a contrast below a relatively high threshold are removed. The temporary image represents a transformation of the input image in which details with a contrast above a low threshold are enhanced, details with a contrast below the low threshold are removed, and details above a high threshold are preserved. The high and low threshold may vary from one scale to another. The values that the high and low thresholds are generally non-negative values that range from zero to a practically infinite, positive value. When the low threshold is equal to zero, no details are removed from the temporary image. When the high threshold is practically infinite, all details are removed from the photographic mask, and all details are enhanced in the temporary image. The temporary image includes the details that are transformed to carry out 3D boosting, sharpening, and denoising of an image. In certain USSIP implementations, once the highest-resolution-scale versions of the photographic mask and temporary image are obtained, through a computational process described below, luminance or grayscale values of the photographic mask and temporary image can be used, pixel-by-pixel, as indices into a two-dimensional look-up table to generate output pixel values for a final, resultant, contrast-enhanced output image.

FIGS. 8A-B illustrate, at a high level, generation of the photographic mask and temporary image and use of the photographic mask and temporary image to generate a locally and globally contrast-enhanced, sharpened, and denoised output image. FIG. 8A shows the first portion of computation in the USSIP leading to computation of a photographic mask and temporary image at the highest-resolution scale, s₀, the original scale of the input image. In FIG. 8A, scales of various intermediate images are represented by horizontal regions of the figure, each horizontal region corresponding to a different scale. The top-level horizontal region represents the highest-resolution scale s₀ 802. The next-highest horizontal region represents a next-lowest resolution scale s₁ 804. FIG. 8A shows three additional lower-resolution scales 806-808. At each scale, four different intermediate images are generated. For example, at scale s₀ (802), four intermediate images f₀ 810, l₀ 820, r₀ 830, and t₀ 840 are generated. At each of N+1 scales i employed within the unified comprehensive image-enhancement method of the present invention, where N may be specified as a parameter or, alternatively, may be an implementation detail, four intermediate images fᵢ, lᵢ, rᵢ, and tᵢ are generated. Each column of intermediate images in FIG. 8A, where each column is headed by one of the highest-resolution-scale intermediate images f₀ 810, l₀ 820, r₀ 830, and t₀ 840, represents a pyramid of intermediate images, widest at the top and decreasing in width, generally by a constant factor, such as “2,” at each level to the smallest, lowest-resolution intermediate image fₙ 814, lₙ 824, rₙ 834, and tₙ 844. Intermediate images 810-814 represent the f pyramid, intermediate images 820-824 represent the l pyramid, intermediate images 830-834 represent the r pyramid, and intermediate images 840-844 represent the t pyramid.

The temporary images computed at each scale include: (1) f₀, f₁, . . . , f_{N}, low-pass intermediate images generated by, for scales of lower resolution than the highest-resolution scale s₀, a robust decimation operator to be described below; (2) l₀, l₁, . . . l_{N}, band-pass intermediate images produced, at scales of greater resolution than the lowest-resolution scale, by subtraction of a bilaterally interpolated image from a corresponding low-pass image, as described below; (3) photographic-mask (“PM”) intermediate images r₀, r₁, . . . , r_{N}, photographic mask images computed using bilateral interpolation, as described below; and (4) temporary-image images (“TI”) t₀, t₁, . . . , t_{N}, computed using bilateral interpolation in a process described below. In certain expressions provided below, the notation fₛ is used to represent the collection of intermediate images in the f pyramid, f₀, f₁, . . . , f_{N}, the notation lₛ is used to represent the collection of intermediate images in the l pyramid, l₀, l₁, . . . , l_{N}, the notation rₛ is used to represent the collection of intermediate images in the r pyramid, r₀, r₁, . . . , r_{N} , and the notation tₛ is used to represent the collection of intermediate images in the t pyramid, t₀, t₁, . . . , t_{N}. The highest-resolution-scale PM and TI intermediate images, 830 and 840, respectively, in FIG. 8A are the photographic mask and temporary image used in a second phase of computation to generate a comprehensively enhanced image for output.

In the computational diagram shown in FIG. 8A, it can be seen, by observing arrows input to each intermediate image, that each intermediate image of the low-pass pyramid f₁, f₂, . . . , f_{N} is computed from a higher-resolution-scale low-pass image, with the first low-pass intermediate image f₀ obtained as the input signal. The successive low-pass intermediate images are computed in an order from next-to-highest-resolution scale s₁ to lowest-resolution scale s_{N}. The band-pass-pyramid intermediate images l₀, l₁, . . . , l_{N-1} may be computed in either top-down or an opposite order, with the lowest-resolution-scale band-pass intermediate image l_{N} obtained as the lowest-resolution-scale low-pass intermediate image f_{N} and higher-resolution-scale band-pass intermediate images l_{N-1}, l_{N-2}, . . . , l₀ each computed from both the next-lower-resolution low-pass image and the low-pass intermediate image at the same scale. The PM intermediate images and TI intermediate images r₀, r₁, . . . r_{N} and t₀, t₁, . . . , t_{N} are computed from next-to-lowest-resolution-scale s_{N-1} to highest-resolution scale s₀. Each higher-resolution-scale PM image rᵢ is computed from rᵢ₊₁, fᵢ, and lᵢ, and each higher-resolution-scale TI image tᵢ is computed from tᵢ₊₁, fᵢ, and lᵢ. Thus, the low-pass pyramid f₀, fᵢ, . . . , f_{N} is computed from base to apex, while the remaining pyramids are computed from apex to base. Computation of each of the different types of intermediate images fᵢ, lᵢ, rᵢ and tᵢ is discussed in separate subsections, below.

FIG. 8B is a high-level control-flow diagram for the USSIP. In step 802, an input signal, generally a photographic image, graphic, or video-signal frame, is received. In step 804, the low-task pyramid f₀, f₁, . . . , f_{N} is computed. In step 805, the band-pass pyramid l₀, l₁, . . . , l_{N} is computed. In step 806, the PM pyramid r₀, r₁, r₂, . . . , r_{N} is computed. In step 807, the TI pyramid t₀, t₁, . . . , t_{N} is computed. Using the highest-resolution-scale PM and TI (830 and 840 in FIG. 8A, respectively), an output signal is computed, in step 808, by using PM and TI pixel values, pixel-by-pixel, as indices of a two-dimensional look-up table to generate output-image pixel values.

The multi-scale pyramid approach discussed above has great advantages in computational efficiency. In alternative approaches, bilateral filters with very large kernels are applied to the images at a single scale in order to attempt to produce intermediate images similar to a photographic mask. However, large-kernel bilateral filter operations are extremely computationally expensive. A multi-scale approach provides results equivalent to those obtained by certain large-kernel bilateral filter operations at a much lower cost in processor cycles and computation time.

In certain currently available image-enhancement methods, each pixel of an image is passed through a one-dimensional look-up table (“1D LUT”), with the 1D LUT designed to achieve the desired effects by amplifying certain portions of an image and compressing certain other portions of the image. In other words, the LUT represents a function applied to pixel values within a range of pixel values, in certain cases multiplying differences of pixel values of the original image by values greater than 1.0, to effect detail amplification, and in other cases multiplying differences of pixel values of the original image by values less than 1.0, to effect detail compression. Implementations of the USSIP are designed to amplify all regions of an image by multiplying the differences of pixels of values of each region by a constant greater than or equal to 1.0. In this family of methods, the PM is passed through a 1D LUT, at least logically, to generate an enhanced PM which is then combined with an intermediate details image obtained by subtracting the PM from the TI. This overall method can be simplified by using a two-dimensional look-up table.

FIG. 9 illustrates a generalized, second part of comprehensive image enhancement according to the present invention. This second part of the present method begins, in FIG. 9, with the PM 902 and TI 904 obtained from the highest-resolution-scale PM intermediate image r₀ and the highest-resolution-scale TI intermediate image t₀ (830 and 840 in FIG. 8A). A details intermediate image 906 is computed by subtracting the PM 902 from the TI 904. The details are then multiplied by a constant k 908 to produce an amplified details intermediate image 910. The PM 902 is transformed through a one-dimensional LUT 912 to generate an enhanced PM 914. The enhanced PM 914 is then added to the amplified details image 910 to produce a final, contrast-enhanced image 916.

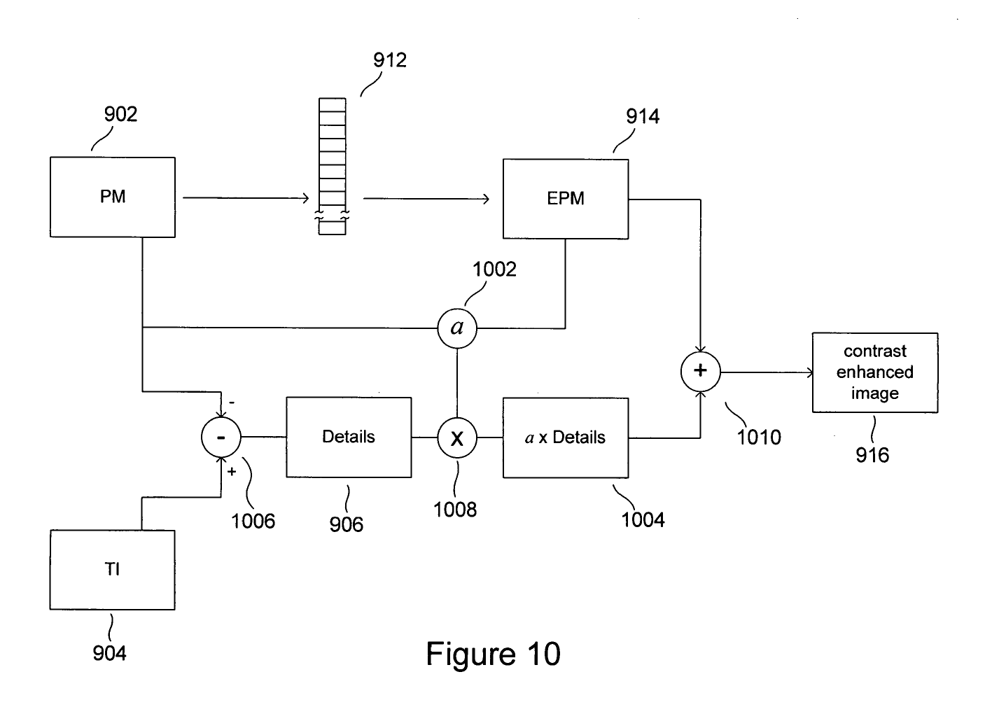

Although FIG. 9 illustrates the general strategy for comprehensive image enhancement in the USSIP, it turns out that more effective image enhancement can be obtained by modifying the approach shown in FIG. 9. FIG. 10 illustrates a modified approach to comprehensive image enhancement in the USSIP. As in FIG. 9, the PM 902 and TI 904 are used to generate the details intermediate image 906 and the enhanced PM 914 via look-up table 912. However, rather than multiplying the details image 906 by a constant, as shown in FIG. 9, the details is transformed, pixel-by-pixel, via function a 1002 to produce a modified details temporary image 1004 in which details are amplified or compressed according to whether the region in which the details are located is amplified or compressed in the enhanced PM 914. The modified details temporary image 1004 and the enhanced PM 914 are then added together to produce the final, comprehensively contrast-enhanced image 916. The details of the computations used to produce the enhanced PM and modified details temporary image are described, in detail, in following subsections.

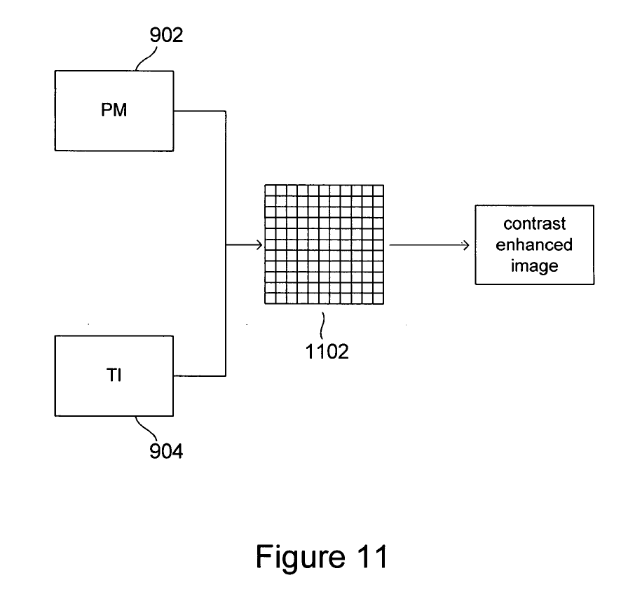

The comprehensive image-enhancement method shown in FIG. 10 that represents a family of USSIP implementations can be further simplified. FIG. 11 shows a simplified version of the image-enhancement method of the present invention shown in FIG. 10. In the simplified version, shown in FIG. 11, the PM and TI 902 and 904 are used, pixel-by-pixel, to generate output-image pixel values via a two-dimensional look-up table 1102. The two-dimensional look-up table 1102 tabulates pre-computed values that represent a combination of the subtraction operation 1006 in FIG. 10, the one-dimensional look-up table 912 in FIG. 10, the function a 1002 in FIG. 10, the multiplication operation 1008 in FIG. 10, and the addition operation 1010 in FIG. 10. Details of all of these operations are discussed, below, in following subsections.

Next, in the following subsections, details regarding computation of each of the different types of intermediate images shown in FIG. 8A, and the details for output-image construction using the PM and TI, are provided with reference to a number of detailed figures and mathematical equations.

### The Low-Pass Pyramid

As discussed above, the low-pass pyramid comprises intermediate images f₀, f₁, . . . , f_{N}. These intermediate low-pass images {fₛ(x, y)}, s=0,1, . . . , N are obtained from an input image f(x, y) as follows:

$${f}_{s} = \{ \begin{matrix}f , & s = 0 \\ RD \{ {f}_{s - 1} \} , & s > 0\end{matrix}$$

RD{.} is a robust decimation operator, consisting of bilateral filtering, followed by 2:1 down sampling:

$$RD \{ g \} ( x , y ) = \frac{{\sum }_{( a , b ) ∈ k} g ( \begin{matrix}2 x - a , \\ 2 y - b\end{matrix} ) k ( a , b ) ϕ [ \begin{matrix}g ( 2 x - a , 2 y - b ) - \\ g ( 2 x , 2 y )\end{matrix} ]}{{\sum }_{( a , b ) ∈ k} k ( a , b ) ϕ [ \begin{matrix}g ( 2 x - a , 2 y - b ) - \\ g ( 2 x , 2 y )\end{matrix} ]}$$

where k(.,.) is a convolution kernel with support K and φ(.) is a symmetric photometric kernel. In one USSIP variant, the convolution kernel k is a 3×3 constant averaging kernel and φ(d) returns the numeric constant 1.0 for |d|<T and otherwise returns 0, where T is a relatively high threshold, such as 50 for a grayscale-pixel-value-range of [0-255]. The number of scales employed in USSIP implementations N is a parameter, and may be set to a value as follows: N=┌log₂[min(w,h)]┐+offset where w and h are the width and height of the input image f in pixels, and offset is a constant, such as the integer value “3.”

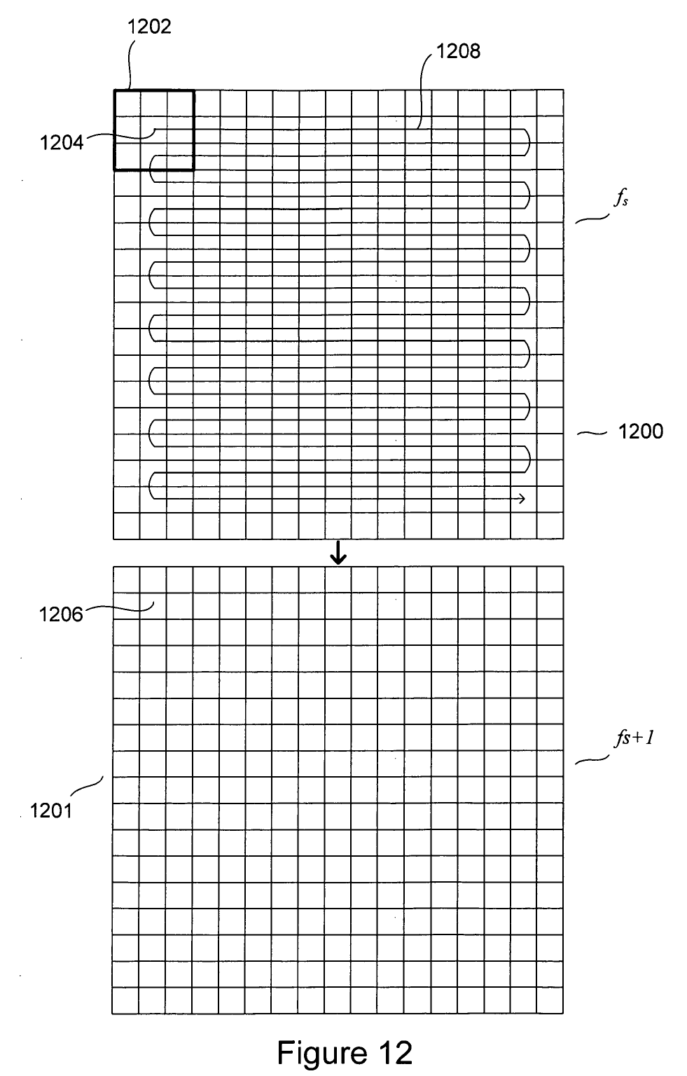

FIGS. 12-15 illustrate computation of intermediate low-pass image of the low-pass pyramid fᵢ. In FIGS. 12-15, bilateral filtering is separated from downscaling, in order to illustrate the two-fold effect of the above describe robust decimation operator. In fact, in a preferred USSIP technique, discussed below, and described in the above-provided equations for the robust-decimation operator, both bilateral filtering and downscaling are accomplished in a single operation, As shown in FIG. 12, the bilateral filtering portion of the computation of an intermediate low-pass image involves a windowing operation, or filter operation, similar to a convolution operation. However, in a filter operation, small neighborhoods, or windows about each pixel, such as window 1202 about pixel 1204, are considered, pixel-by-pixel, with the values of the pixels within the window, or within a neighborhood about a central pixel, used to determine the corresponding value of a corresponding, lower-resolution-scale low-pass intermediate-image pixel 1206. The window is moved, with each operation, to be centered on a next pixel, with the next pixel chosen according to the path 1208 shown in FIG. 12, or another such traversal route, in which each pixel of the intermediate image fₛ to be transformed is considered within the context of the neighborhood about the pixel. Each pixel-and-neighborhood operation on fₛ generates a corresponding pixel value for fₛ₊₁. FIG. 12 illustrates generation of the low-pass intermediate image fₛ₊₁ from the low-pass intermediate image fₛ. As can be seen in the above-provided mathematical description for generation of low-pass intermediate images, the highest-resolution-scale low-pass intermediate image is essentially identical to the input image. It is only for the lower-resolution-scale low-pass intermediate images that the technique shown in FIG. 12 is applied.

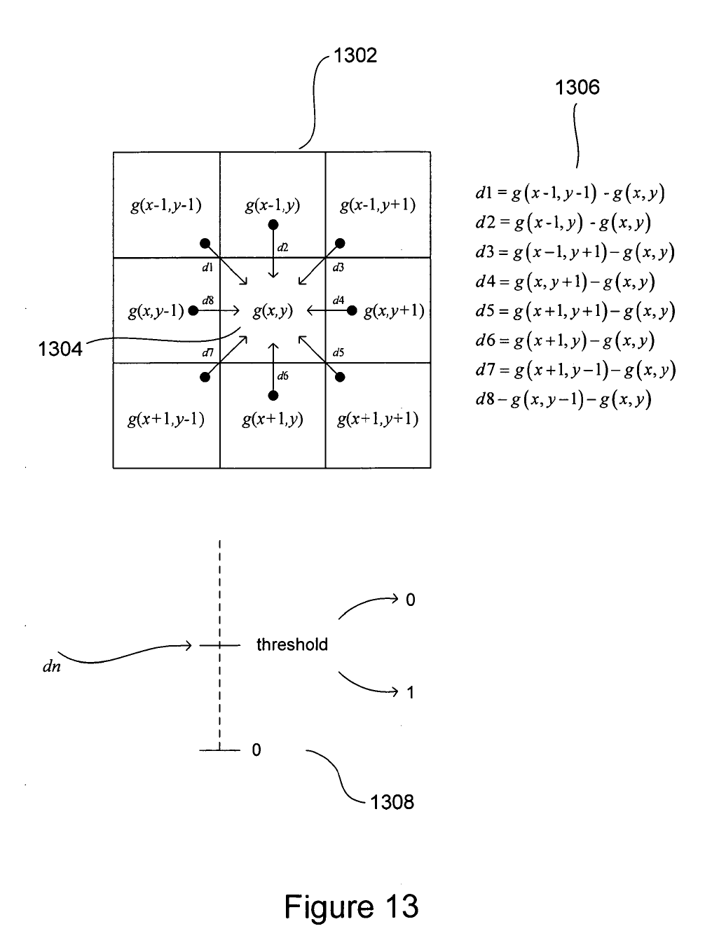

FIG. 13 shows the window, or filter, operation described in the above-provided mathematical expression. As mentioned above, a 3×3 window 1302 is employed in one USSIP technique to represent eight nearest neighbor pixels about a central pixel 1304. In FIG. 13, the pixel values for the pixels are represented using a “g( )” notation, where g(x,y) represents the pixel value for the central pixel 1304, with the numeric value “1” added to, or subtracted from, x, y, or both x and y, are used to represent the values of the neighboring pixels, as also shown in FIG. 13. First, as indicated by the column of expressions 1306 in FIG. 13, differences d1, d2, . . . , d8 are computed by considering each possible pair of pixels comprising a neighboring pixel and the central pixel. The differences dn, where n=8, are obtained by subtracting the pixel value of the central pixel within the window 1304 from the pixel value of each of the neighboring pixels, in turn. Then, as shown in the lower portion of FIG. 13 (1308), the absolute values of the dn values are thresholded to return either the value “0,” when the absolute value of the difference dn is greater than a threshold value T, or the value “1,” when the absolute value of the difference dn is less than the threshold T.

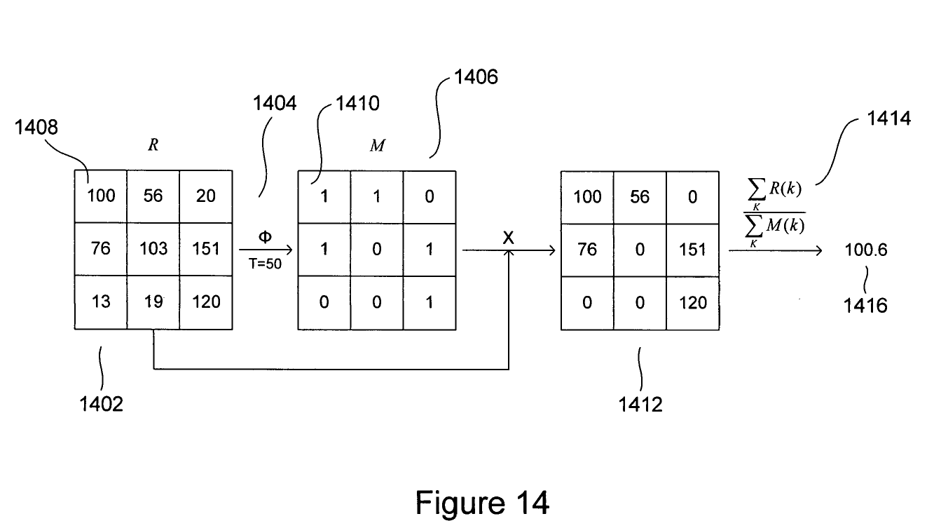

The thresholded do values, where the thresholding function is represented by the function φ(.) in the above-provided mathematical expression, then form a mask that is convolved with the window values of the fₛ image to produce a resultant value for the corresponding pixel of fₛ₊₁ prior to downscaling. FIG. 14 illustrates generation of the mask and convolution of the mask with the neighborhood to produce the pixel value of fₛ₊₁ corresponding to the pixel of fₛ at the center of the window. In FIG. 14, the window or region of fₛ, R, that includes, as the central pixel, a currently considered pixel of fₛ 1402, is thresholded by the function φ(.) where T=50 1404 to produce the corresponding binary mask 1406. For example, the pixel value 100 (1408) is greater than T=50, and therefore the corresponding binary-mask value is “1” (1410). The binary mask is then convolved with, or multiplies, the values of the region R 1402 to produce the convolved-region result 1412. In this result region 1412, only those pixel values within the region R of fₛ with absolute values greater than or equal to 50 remain. The pixel values in the region R with absolute values less than T are replaced, and the resultant region 1412, with the values “0.” Then, the sum of the values in the resultant region 1412 is computed, and divided by the number of non-zero pixel values within the region, as indicated by expression 1414 in FIG. 14, to produce a final resultant pixel value 1416 that is the value for the corresponding pixel fₛ₊₁ prior to downscaling.

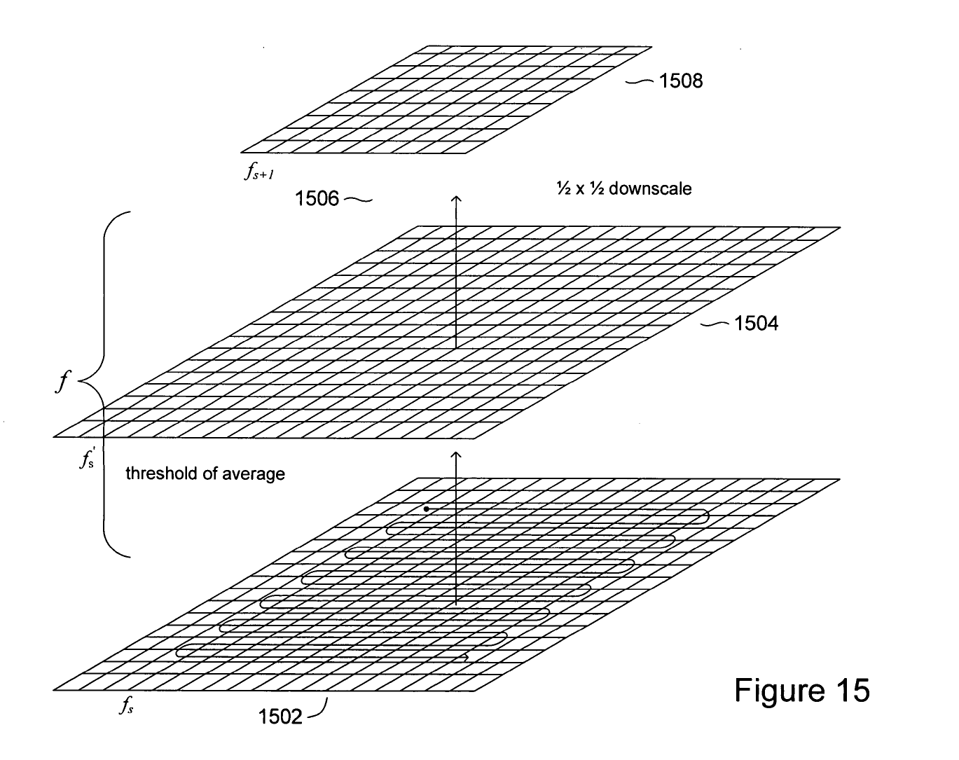

When the entire low-pass intermediate image fₛ (1200 in FIG. 12) is traversed, by the windowing or filtering operation described with reference to FIGS. 13 and 14, above, the resulting temporary fₛ₊₁ intermediate image is downscaled by a ½×½ downscale operation. FIG. 15 thus shows both parts of the bilateral filtering operation represented by the above-provided mathematical expressions. As shown in FIG. 15, the low-pass intermediate image fₛ 1502 is first filtered, as discussed with reference to FIGS. 13-14, to produce a thresholded and averaged intermediate image fₛ 1504 which is then downscaled by a ½×½ downscale operation 1506 to produce the next lower-resolution-scale low-pass intermediate image fₛ₊₁ 1508. Thus, FIGS. 12-15 graphically represent the mathematical operation described above for computing all but the highest-resolution-scale low-pass intermediate image. The result of this operation is to create a series of low-pass intermediate images in which high-contrast features have been removed.

Although the method described in FIGS. 12-15 produce the desired bilaterally filtered and downscaled low-pass intermediate image, both the bilateral filter operation and the downscaling operation are performed in a single step by the robust decimation operator described in the above provided equations. In essence, because of the factor “2” in the above equations for the robust-decimation filter, the windowing operation is actually carried out on every other pixel in the intermediate image fₛ in both the horizontal and vertical directions. Thus, only a number of fₛ₊₁ pixel values equal to approximately ¼ of the pixel values in fₛ are generated by application of the robust decimation operator described by the above-provided equations to the intermediate image fₛ.

The band-pass pyramid {lₛ(x,y)}, s=0,1, . . . , N, is computed from the low-pass pyramid described in the previous subsection, as follows:

$${l}_{s} = \{ \begin{matrix}{f}_{s} - RI \{ {f}_{s + 1} , {f}_{s} \} , & s < N \\ {f}_{N} , & s = N\end{matrix}$$

where RI{.,.} is a novel bilateral 1:2 interpolator, which takes its weights from the higher scale image, as follows:

$$RI \{ {f}_{s + 1} , {f}_{s} \} ( x , y ) = \{ \begin{matrix}{f}_{s + 1} ( \frac{x}{2} , \frac{y}{2} ) & x is even , y is even \\ \frac{{g}_{NWN} + {g}_{s} {w}_{s}}{{w}_{N} + {w}_{s}} & x is odd , y is even \\ \frac{{g}_{E} {w}_{E} + {g}_{w} {w}_{w}}{{w}_{E} + {w}_{W}} & x is even , y is odd \\ \frac{\begin{matrix}{g}_{NE} {w}_{NE} + {g}_{NW} {w}_{NW} + \\ {g}_{SE} {w}_{SE} + {g}_{SW} {w}_{SW}\end{matrix}}{{w}_{NE} + {w}_{NW} + {w}_{SE} + {w}_{SW}} & x is odd , y is odd\end{matrix}$$

where:

$${g}_{N} = {f}_{s + 1} ( \frac{x - 1}{2} , \frac{y}{2} ) , {g}_{S} = {f}_{s + 1} ( \frac{x + 1}{2} , \frac{y}{2} ) , {g}_{W} = {f}_{s + 1} ( \frac{x}{2} , \frac{y - 1}{2} ) , \\ {g}_{E} = {f}_{s + 1} ( \frac{x}{2} , \frac{y + 1}{2} ) , {g}_{NW} = {f}_{s + 1} ( \frac{x - 1}{2} , \frac{y - 1}{2} ) , \\ {g}_{NE} = {f}_{s + 1} ( \frac{x - 1}{2} , \frac{y + 1}{2} ) , {g}_{SW} = {f}_{s + 1} ( \frac{x + 1}{2} , \frac{y - 1}{2} ) , \\ {g}_{SE} = {f}_{s + 1} ( \frac{x + 1}{2} , \frac{y + 1}{2} ) , {w}_{N} = ϕ [ {f}_{s} ( x - 1 , y ) - {f}_{s} ( x , y ) ] , \\ {w}_{s} = ϕ [ {f}_{s} ( x + 1 ) , y - {f}_{s} ( x , y ) ] , {w}_{W} = ϕ [ {f}_{s} ( x , y - 1 ) - {f}_{s} ( x , y ) ] , \\ {w}_{E} = ϕ [ {f}_{s} ( x , y + 1 ) - {f}_{s} ( x , y ) ] , \\ {w}_{NW} = ϕ [ f ( {}_{s} x - 1 , y - 1 ) - {f}_{s} ( x , y ) ] , \\ {w}_{NE} = ϕ [ {f}_{s} ( x - 1 , y + 1 ) - {f}_{s} ( x , y ) ] , \\ {w}_{SW} = ϕ [ {f}_{s} ( x + 1 , y - 1 ) - {f}_{s} ( x , y ) ] , \\ {w}_{SE} = ϕ [ {f}_{s} ( x + 1 , y + 1 ) - {f}_{s} ( x , y ) .$$

Note that, in the above expressions for RI, certain of the denominators, such as the denominator WE+WW in the expression for the x-is-odd, y-is-even case. However, when the denominators are 0, the numerators are also 0, and the value of the ratio is considered to be 0, rather than an undefined value resulting from a 0-valued denominator.

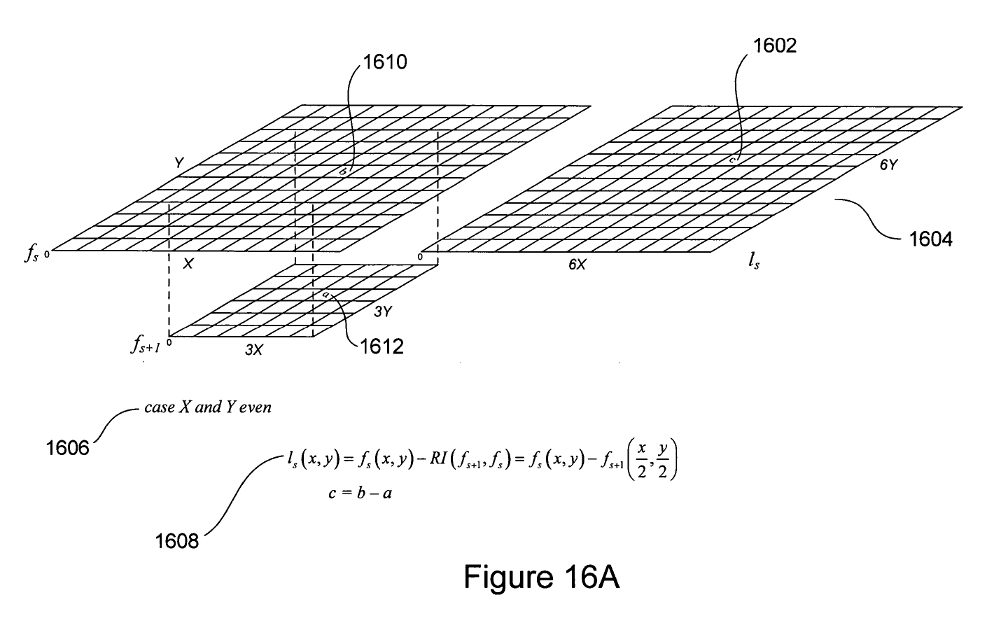

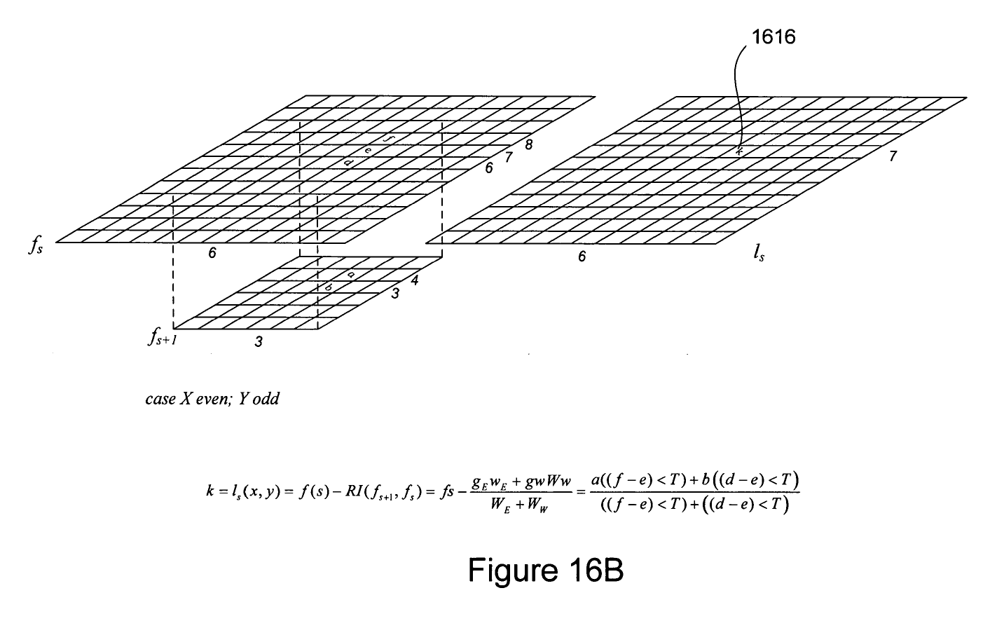

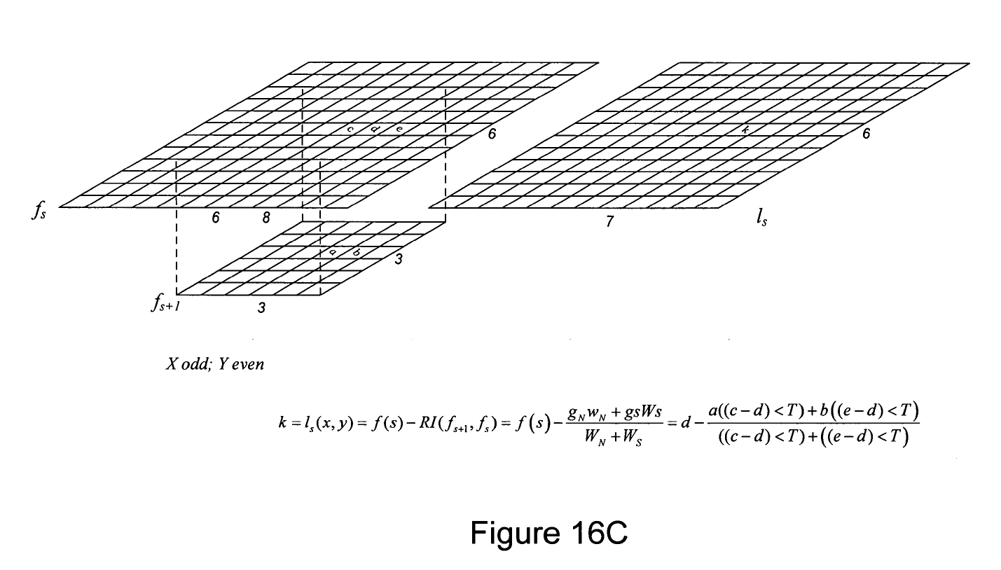

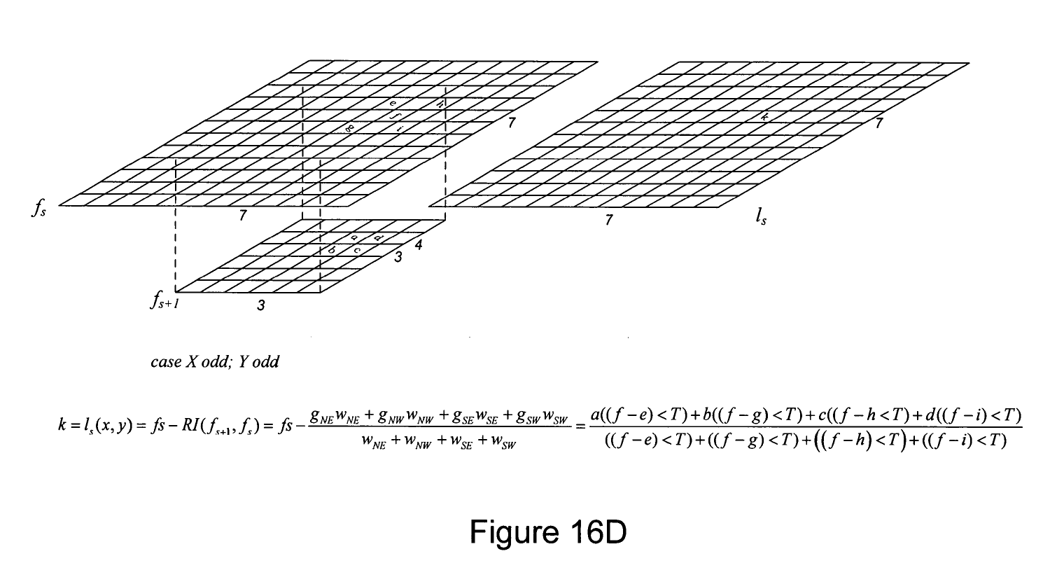

FIGS. 16A-D illustrate computation of individual pixels of a band-pass intermediate image lₛ from neighboring pixels in the low-pass intermediate images fₛ and fₛ₊₁. Neighboring pixels in a lower-resolution-scale image are obtained by downscaling the coordinates of the corresponding pixel of the higher-resolution scale image, as will be shown, by example, in the discussion of FIGS. 16A-D. FIG. 16A corresponds to the first of four different equations for the bilateral 1:2 interpolator RI, discussed above. FIG. 16B illustrates the second of the four equations for the bilateral 1:2 interpolator RI, FIG. 16C illustrates the third of the four equations for the bilateral 1:2 interpolator RI, and FIG. 16D illustrates the fourth of the four equations for the bilateral 1:2 interpolator RI.

FIG. 16A illustrates computation of the pixel value for a pixel 1602 in lₛ 1604 when the coordinates of the pixel in lₛ are both even 1606. In this case, the expression for lₛ(x,y) 1608 is obtained from the above-provided mathematical expression as:

$${l}_{s} ( x , y ) = {f}_{s} ( x , y ) - RI ( {f}_{s + 1} , {f}_{s} ) = {f}_{s} ( x , y ) - {f}_{s + 1} ( \frac{x}{2} , \frac{y}{2} )$$

As can be seen in FIG. 16A, the pixel value of fₛ(x,y) is b 1610 and the pixel value for

$${f}_{s + 1} ( \frac{x}{2} , \frac{y}{2} )$$

is a 1612. Thus, substituting these pixel values into the above expression, the pixel value for pixel 1602 in lₛ can be computed as:

c=b−a

FIG. 16B illustrates computation of the value of a pixel in a band-pass intermediate image lₛ 1616 in the case that the x coordinate is even and the y coordinate is odd. From the above mathematical expressions, the expression for the value of the pixel lₛ(x,y), k in FIG. 16B, is given by:

$$\begin{matrix}k = {l}_{s} ( x , y ) \\ = {f}_{s} - RI ( {f}_{s + 1} , {f}_{s} ) \\ = {f}_{s} - \frac{{g}_{E} {w}_{E} + gwWw}{{W}_{E} + {W}_{W}} \\ = \frac{a ( ( f - e ) < T ) + b ( ( d - e ) < T )}{( ( f - e ) < T ) + ( ( d - e ) < T )}\end{matrix}$$

where expressions of the form (a−b)<c are Boolean-valued relational expressions, having the value 0 when a−b≧T and having the value 1 when a−b<T. FIG. 16C shows, using similar illustration conventions, computation of the pixel value of a pixel in lₛ, lₛ(x,y), when x is odd and y is even. Finally, FIG. 16D shows, using similar illustration conventions as used in FIG. 16A-C, computation of a pixel value in lₛ, lₛ(x,y) when both x and y are odd.

Thus, computation of a band-pass intermediate image is a pixel-by-pixel operation that uses corresponding pixels, and pixels neighboring those corresponding pixels, in fₛ and fₛ₊₁. The band-pass intermediate images retain medium-contrast details, with high-contrast details and low-contrast details removed.

### PM Intermediate Image Computation

The intermediate images rₛ of the PM intermediate-image pyramid are computed as follows:

$${r}_{s} = \{ \begin{matrix}{l}_{s} , & s = N \\ RI \{ {r}_{s + 1} , {f}_{s} \} + {l}_{s} [ 1 - ϕ ( {l}_{s} ) ] , & s < N\end{matrix}$$

where the term lₛ[1−φ(lₛ)] returns lₛ, if the absolute value of lₛ is larger than T, and 0 otherwise.

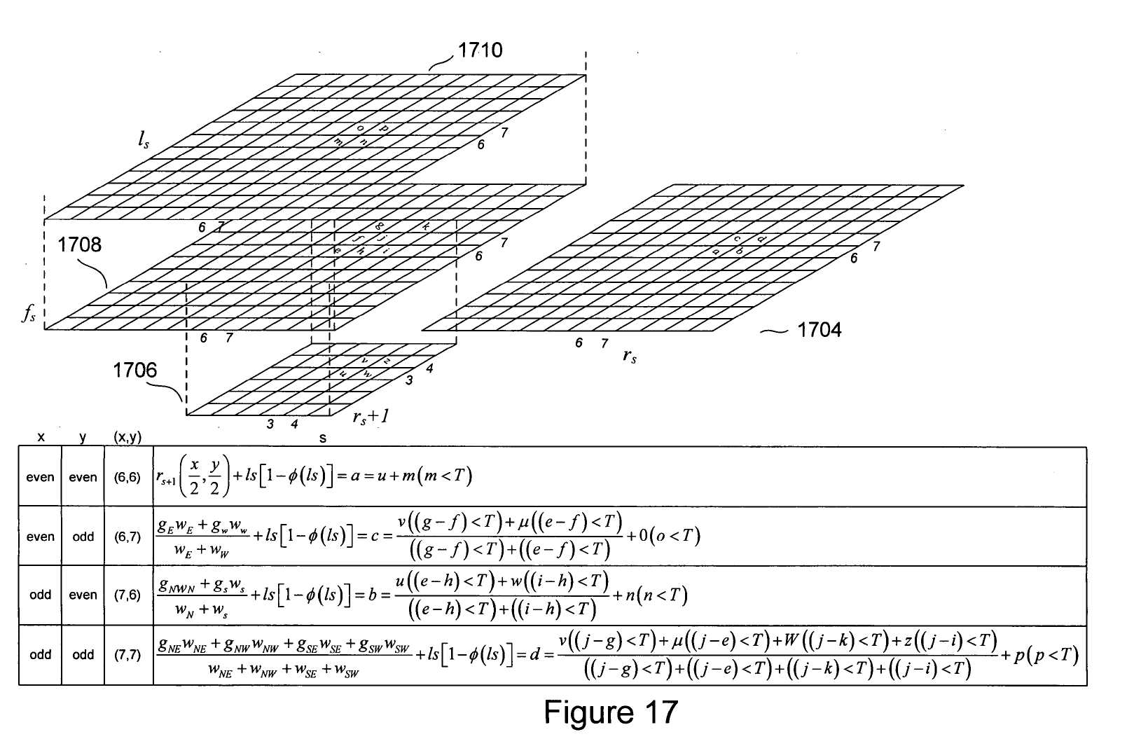

FIG. 17 illustrates, using similar illustrations as used in FIGS. 16A-D, computation of pixels in rₛ for four different coordinate-parity cases. Each coordinate-parity case represents one choice of the coordinates x and y being either odd or even. The table 1702 in the lower portion of FIG. 17 illustrates mathematical expressions for each of the four different coordinate-parity cases, derived from the above generalized mathematical expression for computing rₛ. As discussed above, the PM intermediate image rₛ 1704 is computed based on the next-lower-scale PM intermediate image rₛ₊₁ 1706, the low-pass intermediate image fₛ 1708, and the band-pass intermediate image lₛ 1710. The PM intermediate images have all low and mid-contrast details removed, leaving a high-resolution photographic mask in the highest-resolution-scale PM intermediate image r₀.

### Computation of the TI Intermediate Images

Computation of the TI intermediate images tₛ is a pixel-by-pixel operation involving the next-lowest-scale TI intermediate image tₛ₊₁, the low-pass intermediate image fₛ, and the band-pass intermediate image lₛ, expressed as follows:

$${t}_{s} = \{ \begin{matrix}{l}_{s} , & s = N \\ RI \{ {t}_{s + 1} , {f}_{s} \} + {l}_{s} [ 1 - ψ ( {l}_{s} ) ] , & s < N\end{matrix}$$

where ψ is a function defined as follows:

when |lₛ(x,y)|>T,

ψ[lₛ(x,y)]=lₛ(x,y),

when |lₛ(x,y)|<T_{N}, where T_{N} is a scale-dependent some noise threshold,

ψ[lₛ(x,y)]=c_{N}lₛ(x,y), where c_{N}<1.

when T_{N}≦|lₛ(x,y)|≦T,

ψ[l(x,y)]=min{cₛ(lₛ(x,y)−TN)+c_{N}T_{N},T},

where cₛ≧1.

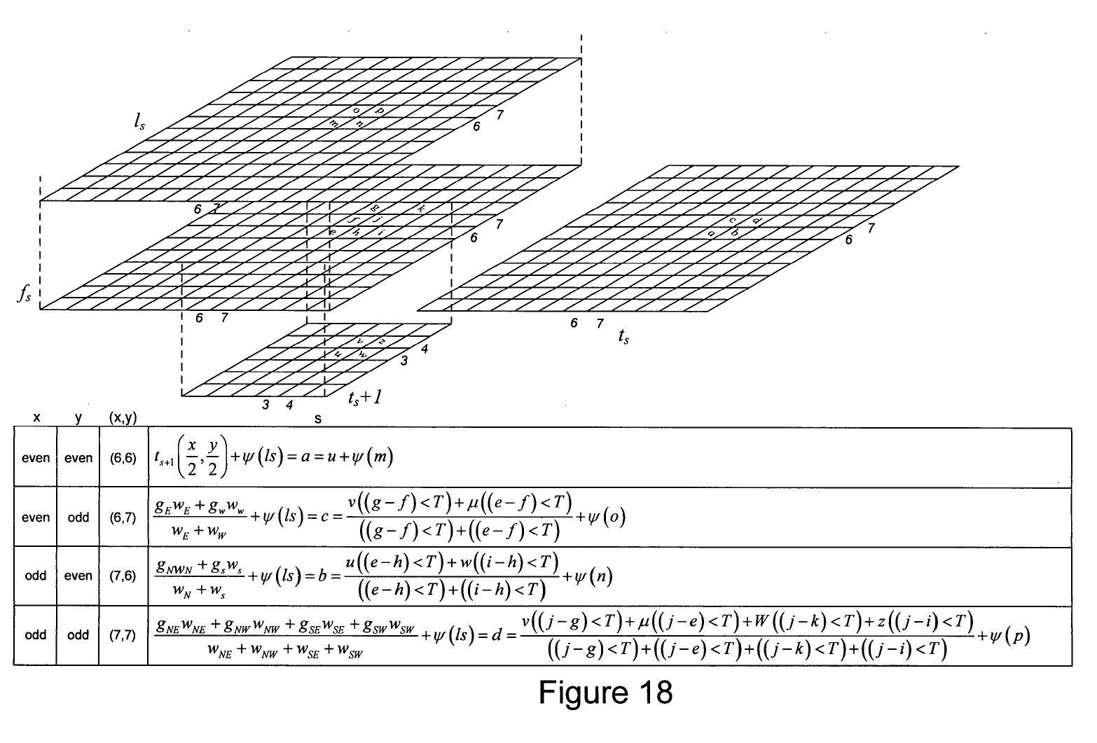

FIG. 18 illustrates, using illustration conventions similar to those used in FIGS. 16A-D and FIG. 17, computation of pixels in tₛ for each of the coordinate-parity cases. Note that the function ψ depends on the threshold values T_{N} and constants c_{N} and cₛ, and thus, in FIG. 18, symbolic values returned by ψ are not provided, with values returned by simply indicated by functional notation. The TI intermediate images retain high-contrast details, include enhanced mid-contrast details, and include compressed or reduced low-contrast details. In other words, strong or high-contrast edges are not over-sharpened, important details are enhanced, and noise is reduced. In general, T_{N} is set to a value greater than 0 only for the highest-resolution scales. C_{N} is, in one implementation, set to 0.5. The threshold T_{N} is determined, based on an estimate of the noise within an image, by any of various noise-estimation techniques. In alternative implementations, c_{N} may consist of two multiplicative terms, one constant for all scales, and the other increasing for the highest-resolution scales. The first of the multiplicative terms accounts for 3D boosting, and the latter of the multiplicative terms provides for sharpening.

### Computation of Output Image Based on PM and TI

Returning to FIG. 10, details of the computation of the output contrast-enhanced image are next provided. Each pixel of the output image, o(x,y) is obtained from the corresponding pixels of the temporary image t(x,y) and the photographic mask m(x,y) by:

o(x,y)=L[m(x,y)]+d(x,y)a(x,y)

where d(x,y)=t(x,y)−m(x,y), and

$$a ( x , y ) = \{ \begin{matrix}L [ m ( x , y ) ] / m ( x , y ) , & L [ m ( x , y ) ] \geq m ( x , y ) \\ \frac{( 255 - L [ m ( x , y ) ] )}{( 255 - m ( x , y ) )} , & otherwise .\end{matrix}$$

Thus, if the currently considered pixel is in a region that is brightened by a multiplicative factor greater than 1, from a₁ to a₂>a₁, then the function a returns the value a₂/a₁. However, when the region is being darkened, from a₁ to a₂ where a₂<a₁, then the function a returns (255−a₂)/(255−a₁) which is equivalent to inverting the input image, multiplying the particular region by a constant larger than 1, and then re-inverting the input image. These computations, represented by the above expressions, can be pre-computed for all t and m values, and incorporated into the two-dimensional look-up table 1102 in FIG. 11 as follows:

L₂(t,m)=L(m)+(t−m)a

for all t and m ranging from 0 to 255, where a is equal to L(m)/m if L(m)≧m, or (255−L(m))/(255−m) otherwise.

With the two-dimensional look-up table L2 precomputed, the output image can be generated by a lookup operation, as shown in FIG. 11:

o(x,y)=L₂[t(x,y),m(x,y)]

One advantage of using the 2D LUT is that one may ensure that no saturation occurs at grayscale or luminance endpoints, such 0 and 255 for a 256-value grayscale or luminance range, by rounding the curve towards (0,0) or (255,255) as |t−m| increases.

The one-dimensional look-up table L that appears in the above expressions, and that is incorporated in the two-dimensional look-up table L₂, can have many different forms and values. In one USSIP technique, the one-dimensional look-up table L simultaneously performs three tasks: (1) image histogram stretching; (2) gamma correction for brightening or darkening the image, as appropriate; and (3) shadow lighting and highlight detailing. This one-dimensional look-up table is computed from a histogram and normalized cumulative histogram of the grayscale values of black-and-white images or the luminance channel of color images. Lookup tables are essentially discrete representations of arbitrary functions applied to pixel values, and many different functions can be represented by a lookup table to accomplish many different purposes.

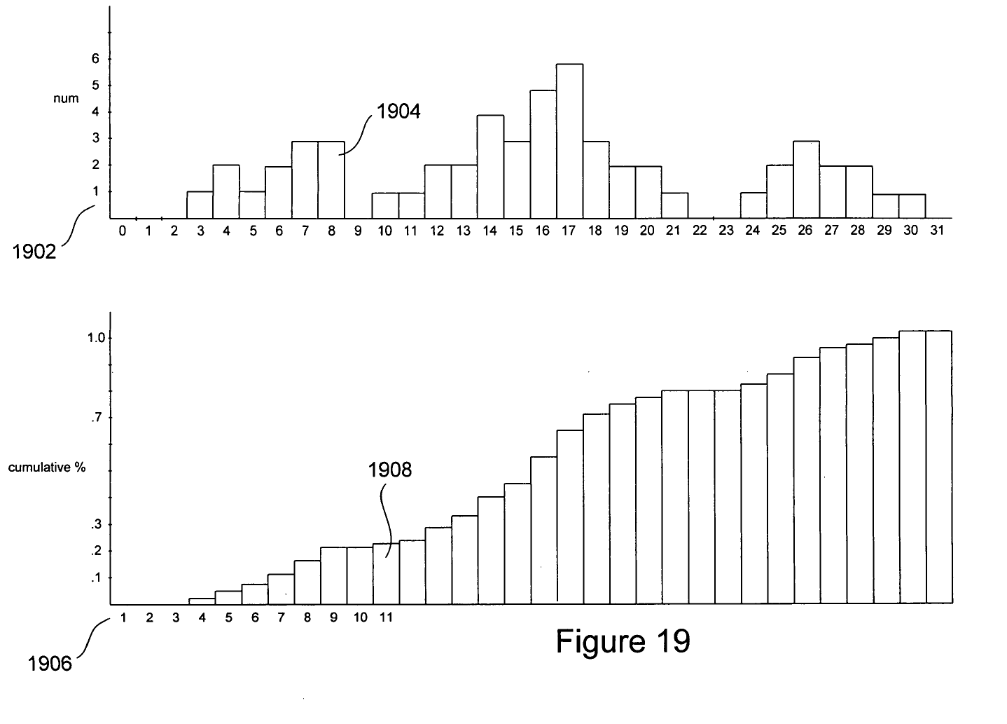

FIG. 19 shows an example histogram and cumulative histogram. The example histogram 1902 shows the number of pixels within an image having each of the possible luminance or grayscale values. In FIG. 19, the histogram and cumulative histogram are based on only 32 possible grayscale or luminance-channel values, but in many systems, the number of possible values is at least 256. Thus, in the histogram 1902 shown in FIG. 19, the bar 1904 indicates that there are three pixels within the image having grayscale value or luminance-channel value 8. The histogram can be expressed as:

h(x)

where x is grayscale or luminance value and h(x) determines the number of pixels in an image having the grayscale or luminance-channel value x.

A normalized cumulative histogram h̅(x) 1906 corresponding to the histogram 1902 is provided in the lower portion of FIG. 19. In a normalized cumulative histogram, each column represents the fraction of pixels within an image having grayscale or luminance values equal to or less than a particular x-axis value. For example, in the normalized cumulative histogram 1906 in FIG. 19, corresponding to histogram 1902 in FIG. 19, the vertical bar 1908 indicates that 25 percent of the pixels in the image have grayscale or luminance-channel values equal to, or less than, 11. As can be seen in the normalized cumulative histogram shown in FIG. 19, the normalized cumulative histogram function h̅(x) is a non-decreasing function ranging from 0.0 to 1.0. The normalized cumulative histogram can be expressed as:

$$\overline{h} ( x ) = \frac{{\sum }_{y = 0}^{x} h ( y )}{{\sum }_{y = 0}^{255} h ( y )}$$

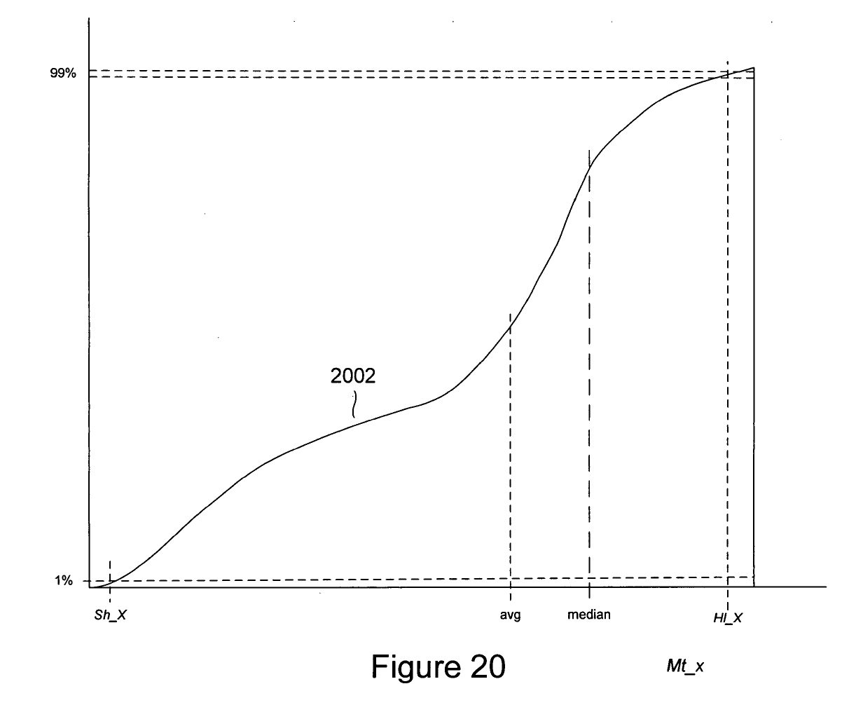

FIG. 20 shows a hypothetical normalized cumulative histogram for an example image. The normalized cumulative histogram function h̅(x) 2002 is displayed as a somewhat bimodal curve. Three values Sh_X, Mt_X, and Hl_X are computed from the normalized cumulative histogram as indicated in FIG. 20. Sh_X is the grayscale or luminance-channel value X for which h̅(x) returns 0.01. Hl_X is the X value for which h̅(x) returns 0.99. Mt_X can be defined either as the average value or median value of the grayscale values or luminance-channel values of the image. For example, the median of the luminance-channel values is a value X such that h̅(x)≦0.5 and h̅(x+1)>0.5. The value Sh_X is referred to as the “input shadows,” the value Hl_X is referred to as the “input highlights,” and the value Mt_X is referred to as the “input mid-tones.” Corresponding values Sh_Y, referred to as “output shadows,” Hl_Y, referred to as “output highlights,” and Mt_Y, referred to as “output mid-tones,” are computed, in one USSIP technique as:

Sh_{—}Y=(Sh_{—}X+(0.01×255))/2,

Hl_{—}Y=(Hl_{—}X+(0.99×255))/2

Mt_{—}Y=(Mt_{—}X+128)/2

In one USSIP technique, the one-dimensional look-up table L can then be computed, using the above-derived terms as well as a strength parameter s, by:

$$L ( x ) = ( Hl\_Y - Sh\_Y ) {( \frac{x - Sh\_X}{Hl\_X - Sh\_X} )}^{a {2}^{′β}} + Sh\_Y , \\ for Sh\_X \leq x \leq Hl\_X$$

where

$$a = log [ \frac{( Mt\_Y - Sh\_Y ) ( Hl\_X - Sh\_X )}{( Mt\_X - Sh\_X ) ( Hl\_Y - Sh\_Y )} ] , and$$

$$β = ( \frac{Hl\_Y - Sh\_Y}{Mt\_Y - Sh\_Y} ) {( \frac{x - Sh\_X}{Hl\_X - Sh\_X} )}^{a} - 1.$$

For x smaller than Sh_X, L(x)=x(Sh_Y/Sh_X), and for x larger than Hl_X, L(x)=255−(255−x)(255−Hl_Y)/(255−Hl_X).

### Three Approaches to 3D Boosting

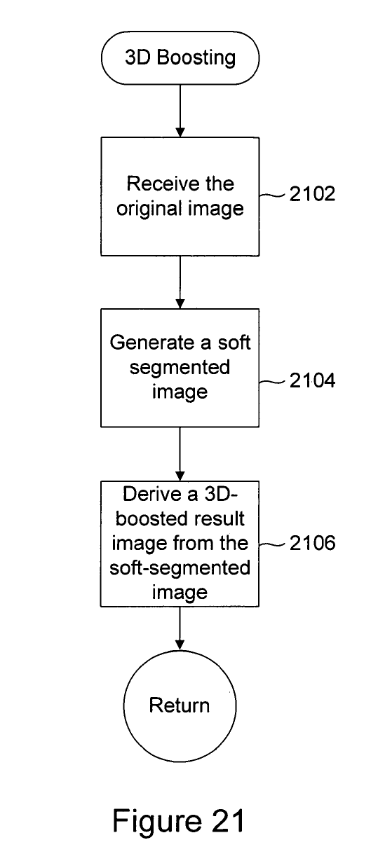

FIG. 21 is a simple flow-control diagram that illustrates the general concept of 3D boosting. In step 2102, an original image is received. In step 2104, a soft-segmented image is produced, by any number of different techniques, three of which are subsequently discussed. Then; in step 2106, a 3D-boosted, result image is produced from the soft-segmented image and the original image.

The soft-segmented image is a transformation of the original image that partitions the original image into relatively homogenous regions of flat contrast, with abrupt, high-contrast edges. The photographic mask, described in the above subsection that details the unified scheme for spatial image processing, is an example of a soft-segmented image. Another example of a soft-segmented image is an upper-envelop photographic mask, denoted subsequently as P̅M̅, that is produced by various implementations of the well-known Retinex method. Versions of the Retinex method are described, for example, in the article “Improving the Retinex Algorithm for Rendering Wide Dynamic Range of Photographs,” by Robert Sobol, Journal of Electronic Imaging, Volume 13(1)/65, January 2004 and also described in U.S. Pat. No. 6,941,028 B2. 3D boosting is a local contrast enhancement technique, as discussed above, that increases the perception, on behalf of a viewer, of depth in a two-dimensional image by increasing the contrast between shaded objects and fully illuminated objects and portions of objects that are shaded and fully illuminated portions of objects. 3D boosting therefore needs to be carried out on areas of mid-range contrast without increasing low-contrast noise and without sharpening or over-sharpening high-resolution, high-contrast detail.

Three different approaches to 3D-boosting method of the present invention are next described. FIG. 22 is a more detailed version of FIG. 21, specific for the first approach. FIG. 22 is a more detailed version of FIG. 21, specific for the first approach. In step 2202, the original image is received. Next, in step 2204, the above-described unified scheme for spatial image processing is employed, in part, to generate the low-pass, band-pass, and photographic-mask pyramids in order to generate the photograph mask PM. Then, in step 2206, the second portion of the unified scheme for spatial image processing, discussed above with reference to FIG. 10, is carried out, using in place of the temporary image (904 in FIG. 10) the original image f₀ (810 in FIG. 8A) generated by the pyramid-generation process and also received in step 2202, above. In addition, the multiplier “a,” generated by the function of the same name, (1002 in FIG. 10) is multiplied by a constant greater than 1.0, in order to amplify the mid-range contrast portions of the image in order to effect 3D boosting. The result of this process is the 3D-boosted result of the first approach to 3D boosting illustrated in FIG. 22, as shown in step 2208. In a “pure 3D-boosting” operation, L is the identity and, consequently, a is 1.0. Therefore, multiplying a by a constant greater than one is equivalent to replacing a by that constant. When L is not identity, then other contrast enhancement effects are added to 3D-boosting.

FIG. 23 illustrates a second approach to 3D boosting. In step 2303, the original image is received. Next, in step 2305, the above-described unified scheme for spatial image processing is used, in part, to generate the low-pass, band-pass, and temporary-image pyramids, with the temporary-image pyramids generated using a TN threshold of zero and a high T threshold at higher resolutions. Producing the temporary image (“TI”) using these thresholds, the first portion of the unified scheme for spatial image processing results in the TI being a 3D-boosted transformation of the original image, as noted in step 2307. For a “pure 3D-boosting” effect, the amount of enhancement of the mid-contrast details should be constant across scales. When this amount varies, other effects may be achieve in addition to 3D-boosting. For instance, if the amount of enhancement increases as the scale becomes smaller (closer to the original scale), sharpening is achieved. Thus, both the first approach to 3D boosting, discussed with reference to FIG. 22, and approach to 3D boosting, discussed with reference to FIG. 23, employ portions of the above-described unified scheme for spatial image processing in order to produce a 3D-boosted image.

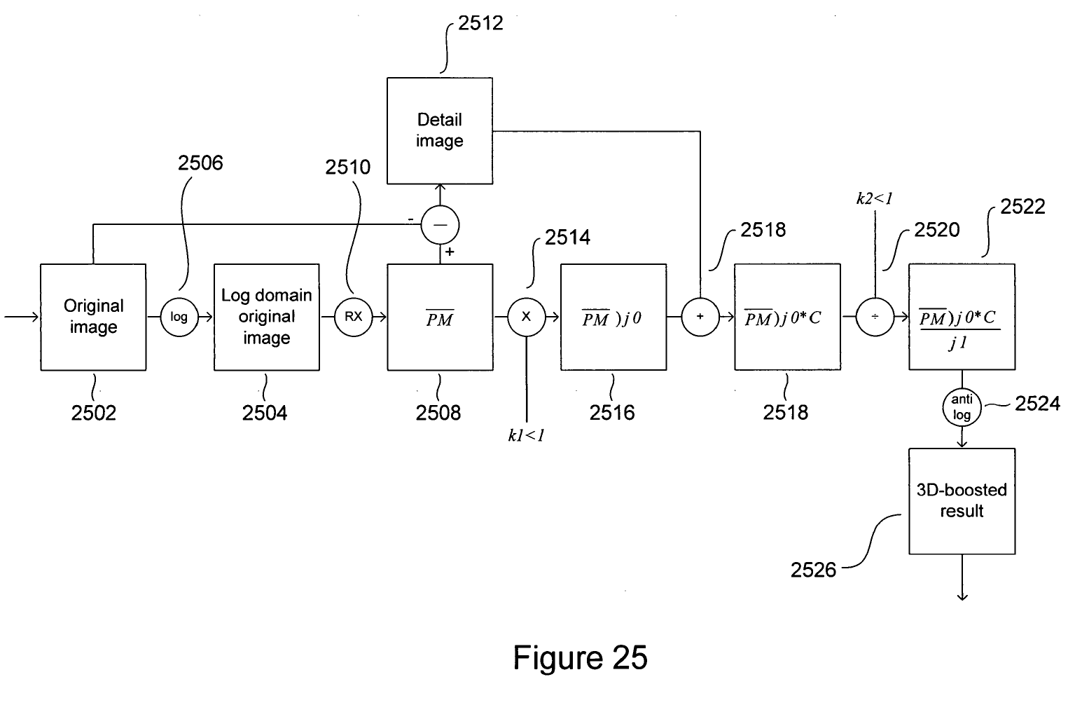

FIGS. 24 and 25 illustrate a third approach to 3D boosting. FIG. 24 is a control-flow diagram that illustrates a third approach to 3D boosting, and FIG. 25 is a schematic-like diagram similar to FIGS. 9-11 in the above subsection describing the unified scheme for spatial image processing. Turning to FIG. 24, the original image is received in step 2402. Next, in step 2404, the original image is transformed to the log domain by taking the log values of the pixel values in the original image in a pixel-by-pixel fashion. The log values may be taken with respect to an arbitrary base, such as 2, e, or 10. Next, in step 2406, an upper envelop photographic mask P̅M̅, is computed using any of various techniques, including the one computed by the well-known Retinex algorithm discussed in the above-cited references. In step 2408, the detail image D is computed by pixel-by-pixel subtracting the original image from P̅M̅. In step 2410, P̅M̅ is pixel-by-pixel multiplied by a first constant k1 to produce the image P̅M̅*k1. In step 2412, the detail image D is added back, pixel-by-pixel, to the results of step 2410 to produce the image P̅M̅*k1+D. In step 2414, the output from step 2412 is pixel-by-pixel divided by a second constant k2 less than 1.0 to produce the intermediate image ( P̅M̅*k1+D)/k2. This intermediate image output from step 2414 is then returned from the log domain back to the original-image domain, in step 2416, by a pixel-by-pixel anti-log operation to produce the final, 3D-boosted image.

FIG. 25 illustrates the approach to 3D boosting using a schematic-like technique. Again, the original image 2502 is transferred to the log domain 2504 by a pixel-by-pixel logarithm operation 2506. The log domain image 2504 is then transformed to an upper-envelope photographic mask P̅M̅, 2508 via any of a number of techniques, including the Retinex algorithm-based techniques 2510. A detail image 2512 is produced by pixel-by-pixel subtracting the original image 2502 from the P̅M̅. The P̅M̅ 2508 is modified by pixel-by-pixel multiplication by constant k1 which is less than 1.0 2514 to produce P̅M̅*k1 2516. The detail image is added back to intermediate image 2516, pixel-by-pixel, to produce intermediate image 2520, P̅M̅*k1+D. Intermediate image 2518 is then pixel-by-pixel divided by constant k2 which is less than 1.0 to produce intermediate image 2522,

$$\frac{\overline{PM} * k 1 + D}{k 2} .$$

Finally, in intermediate image 2522 is returned to the original-image domain via a pixel-by-pixel anti-log operation 2524 to produce the resulting 3D-boosted image 2526.

### Face and Skin Sensitive Image Enhancement

In this subsection, a system that generates both a face map and a skin map from an input image is described as one example of face-map and skin-map generation. The face map includes, for each pixel of an input image, a respective face probability value indicating a degree to which the pixel corresponds to a human face, where variations in the face probability values are continuous across the face map. In certain approaches, the face map is derived from a skin map that includes, for each pixel of an input image, a respective skin probability value indicating a degree to which the pixel corresponds to human skin.

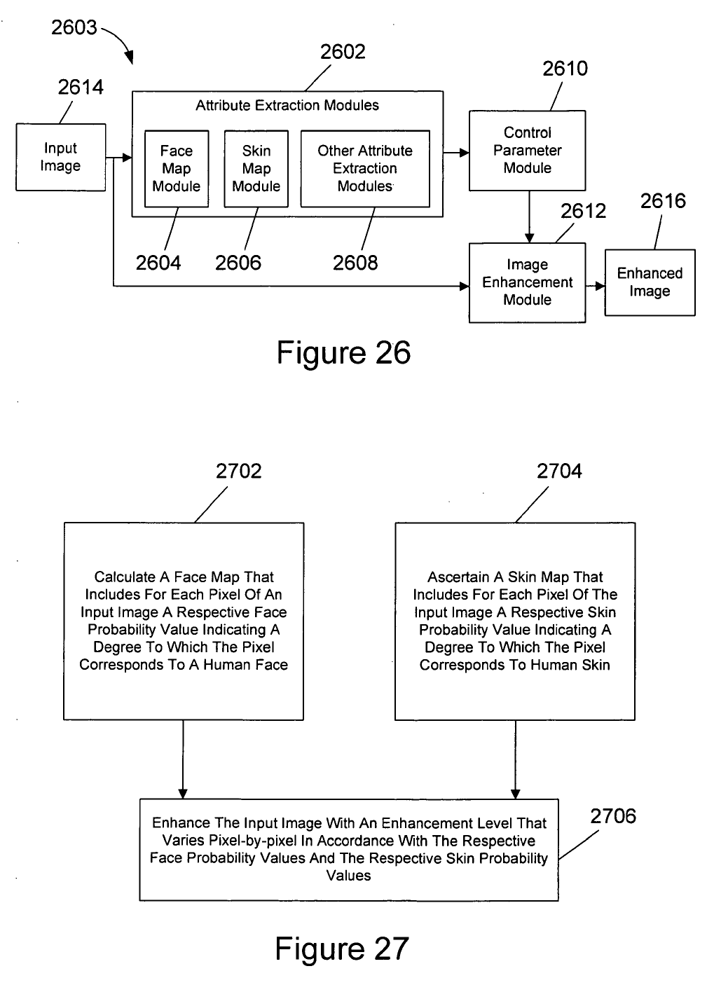

FIG. 26 shows a diagram of an image enhancement system 2603 that includes a set 2602 of attribute extraction modules, including a face-map module 2604, a skin-map module 2606, and possibly one or more other attribute extraction modules 2608. The image enhancement system also includes a control parameter module 2610 and an image enhancement module 2612. In operation, the image enhancement system 2603 performs one or more image enhancement operations on an input image 2614 to produce an enhanced image 2616. In the process of enhancing the input image, the attribute extraction modules determine respective measurement values based on values of pixels of the input image. The control parameter module 2610 processes the measurement values to produce control parameter values, which are used by the image enhancement module to produce the enhanced image from the input image.

FIG. 27 shows a method that is implemented by the image processing system. In FIG. 2, the face-map module (2604 in FIG. 26) calculates 2702 a face map that includes, for each pixel of the input image, a respective face probability value indicating a degree to which the pixel corresponds to a human face. The face probability values generally continuously vary across the face map, with the face probability values for adjacent pixels generally having similar values. This approach avoids artifacts and other discontinuities that might otherwise result from a segmentation of the input image into discrete facial regions and non-facial regions.

The skin-map module computes 2704 a skin map that includes, for each pixel of the input image, a respective skin probability value indicating a degree to which the pixel corresponds to human skin. In this process, the skin-map module maps all pixels of the-input image having similar values to similar respective skin probability values in the skin map. This approach avoids both artifacts and other discontinuities that otherwise might result from a segmentation of the input image into discrete human-skin toned regions and non-human-skin toned regions and artifacts and other discontinuities that otherwise might result from undetected faces or partly detected faces. The order in which the face-map module and the skin-map module determine the face map and the skin map is immaterial.

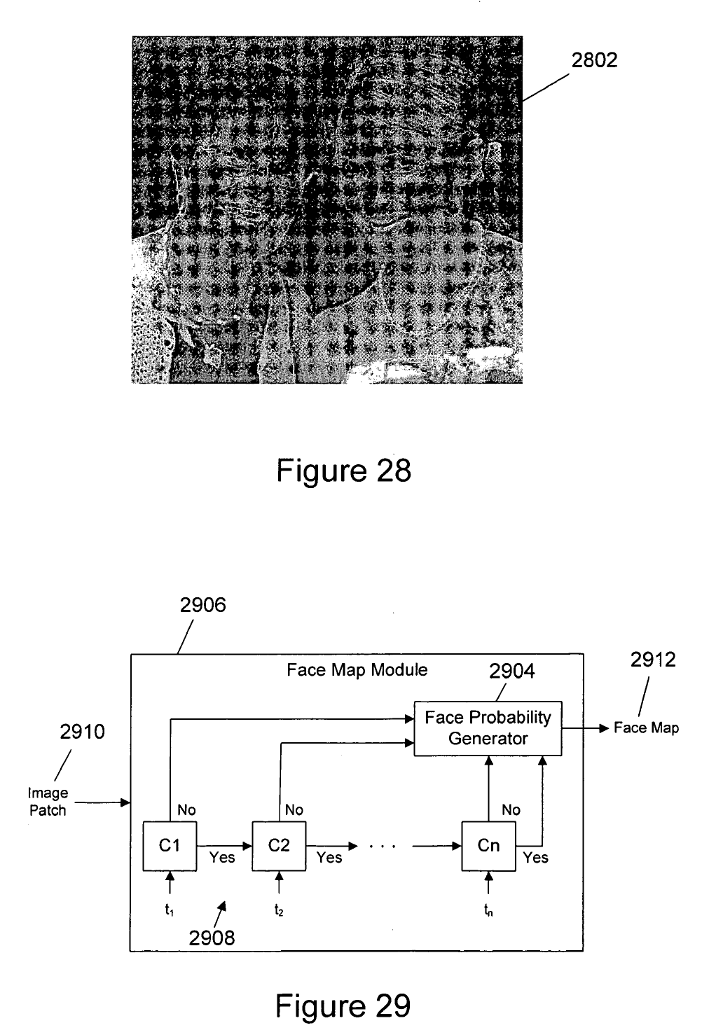

In certain image-processing systems, the control parameter module and the image enhancement module cooperatively enhance 2706 the input image with an enhancement level that varies pixel-by-pixel in accordance with the respective face probability values and the respective skin probability values. The measurement values that are generated by the attribute extraction modules are permitted to vary continuously from pixel-to-pixel across the image. This feature allows the control parameter module to flexibly produce the control parameter values in ways that more accurately coincide with a typical observer's expectations of the image enhancements that should be applied to different contents of the image. In this way, the image enhancement module can enhance the input image with an enhancement level that is both face and skin sensitive. FIG. 28 shows an example of an input image that contains two human faces. In the following discussion, the exemplary image 2802 and the various image data derived from that image are used for illustrative purposes to explain one or more aspects of an approach to face-ma- and skin-map generation.

In general, the face-map module may calculate the face probability values indicating the degrees to which the input image pixels correspond to human face content in a wide variety of different ways, including template-matching techniques, normalized correlation techniques, and eigenspace decomposition techniques. In some approaches, the face-map module initially calculates the probabilities that patches of the input image correspond to a human face and then calculates a pixel-wise face map from the patch probabilities. FIG. 29 shows a diagram of a face-map module. Certain approaches to face-map generation include a face-detection module that rejects patches part-way through an image patch evaluation process in which the population of patches classified as “faces” are progressively more and more likely to correspond to facial areas of the input image as the evaluation continues. A face probability generator 2904 uses the exit point of the evaluation process as a measure of certainty that a patch is a face.

The face-map module 2906 shown in FIG. 29 includes a cascade 2908 of classification stages C₁, C₂, . . . , Cₙ, where n has an integer value greater than 1, also referred to as “classifiers,” and the face probability generator 2904. In operation, each of the classification stages performs a binary discrimination function that classifies a patch 2910 that is derived from the input image as belonging to a face class or a non-face class based on a discrimination measure that is computed from one or more attributes of the image patch. The discrimination function of each classification stage typically is designed to detect faces in a single pose or facial view (e.g., frontal upright faces). Depending on the evaluation results produced by the cascade 2908, the face probability generator 2904 assigns a respective face probability value to each pixel of the input image and stores the assigned face probability value in a face map 2912.

Each classification stage Cᵢ of the cascade 2908 has a respective classification boundary that is controlled by a respective threshold tᵢ, where i=1, . . . , n. The value of the computed discrimination measure relative to the corresponding threshold determines the class into which the image patch is classified by each classification stage. For example, when the discrimination measure that is computed for the image patch is above a threshold for a classification stage, the image patch is classified as belonging to the face class, but when the computed discrimination measure is below the threshold, the image patch is classified as belonging to the non-face class.

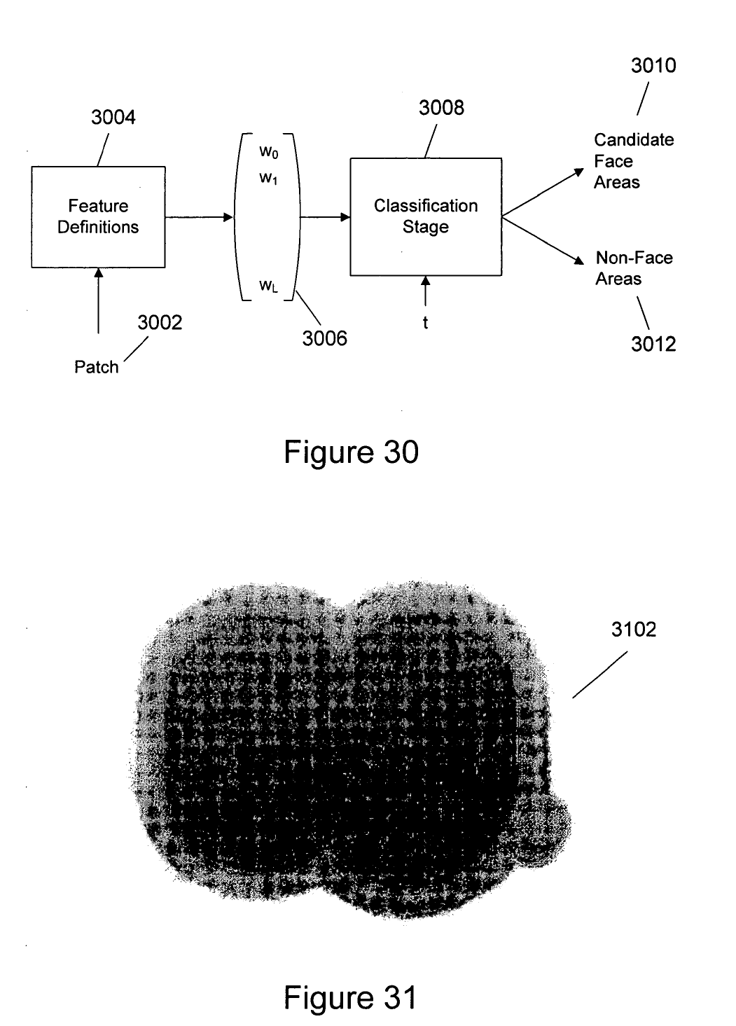

FIG. 30 shows a diagram of a single classification stage in a classifier cascade. An image patch 3002 is projected into a feature space in accordance with a set of feature definitions 3004. The image patch includes any information relating to an area of an input image, including color values of input image pixels and other information derived from the input image needed to compute feature weights. Each feature is defined by a rule that describes how to compute or measure a respective weight (w₀, w₁, . . . , w_{L}) for an image patch that corresponds to the contribution of the feature to the representation of the image patch in the feature space spanned by the set of feature definitions 3004. The set of weights (w₀, w₁, . . . , w_{L}) that is computed for an image patch constitutes a feature vector 3006. The feature vector is input into the classification stage 3008. The classification stage classifies the image patch into a set 3010 of candidate face areas or a set 3012 of non-face areas. If the image patch is classified as a face area, it is passed to the next classification stage, which implements a different discrimination function.

In some implementations, the classification stage 3008 implements a discrimination function that is defined by:

$${\sum }_{l = 1}^{L} {g}_{l} {h}_{l} ( u ) > 0$$

where u contains values corresponding to the image patch and gᵢ are weights that the classification stage applies to the corresponding threshold function h₆(u), which is defined by:

$${h}_{l} ( u ) = \{ \begin{matrix}1 , & if {p}_{l} {w}_{l} ( u ) > {p}_{l} {t}_{l} \\ 0 , & otherwise\end{matrix} \qquad ( 2 )$$

The variable pᵢ has a value of +1 or −1 and the function w(u) is an evaluation function for computing the features of the feature vector 3006.

The classifier cascade processes the patches of the input image through the classification stages (C₁, C₂, . . . , Cₙ), where each image patch is processed through a respective number of the classification stages depending on a per-classifier evaluation of the likelihood that the patch corresponds to human face content. The face probability generator calculates the probabilities that the patches of the input image correspond to human face content (i.e., the face probability values) in accordance with the respective numbers of classifiers through which corresponding ones of the patches were processed. For example, in one approach, the face probability generator maps the number of unevaluated stages to a respective face probability value, where large numbers are mapped to low probability values and small numbers are mapped to high probability values. The face probability generator calculates the pixel-wise face map from the patch probabilities (e.g., by assigning to each pixel the highest probability of any patch that contains the pixel).

The pixel-wise face probability values typically are processed to ensure that variations in the face probability values are continuous across the face map. In some approaches, the face probability values in each detected face are smoothly reduced down to zero as the distance from the center of the detected face increases. In some of these approaches, the face probability of any pixel is given by the original face probability value multiplied by a smooth monotonically decreasing function of the distance from the center of the face, where the function has a value of one at the face center and value of zero a specified distance from the face center. In one approach, a respective line segment is placed through the center of each of the detected faces and oriented according to the in-plane rotation of the detected face. The probability attached to any pixel in a given one of the detected face regions surrounding the respective line segment is then given by the face probability value multiplied by a clipped Gaussian function of the distance from that pixel to the respective line segment. The clipped Gaussian function has values of one on the respective line segment and on a small oval region around the respective line segment; in other regions of the detected face, the values of the clipped Gaussian function decays to zero as the distance from the respective line segment increases.

In some approaches, each of the image patches is passed through at least two parallel classifier cascades that are configured to evaluate different respective facial views. In these approaches, the face probability generator determines the face probability values from the respective numbers of classifiers of each cascade through which corresponding ones of the patches were evaluated. For example, in one exemplary embodiment, the face probability generator maps the number of unevaluated classification stages in the most successful one of the parallel classifier cascades, where large numbers are mapped to low probability values and small numbers are mapped to high probability values. In some approaches, the classifier cascade with the fewest number of unevaluated stages for the given patch is selected as the most successful classifier cascade. In other approaches, the numbers of unevaluated stages in the parallel stages are normalized for each view before comparing them. The face probability generator calculates the pixel-wise face map from the patch probabilities (e.g., by assigning to each pixel the highest probability of any patch that contains the pixel). The pixel-wise face probability values typically are processed in the manner described in the preceding section to ensure that variations in the face probability values are continuous across the face map. In the resulting face map, face patches have a smooth (e.g. Gaussian) profile descending smoothly from the nominal patch value to the nominal background value across a large number of pixels.

FIG. 6 shows an example of a face map that is generated by the face-map module of FIG. 26 from the example input image (2802 in FIG. 3) in accordance with the multi-view based face map generation process described above. In this face map 3102, darker values correspond to higher probabilities that the pixels correspond to human face content and lighter values correspond to lower probabilities that the pixels correspond to human face content.

As explained above, the skin-map module generates a skin map that includes, for each pixel of the input image, a respective skin probability value indicating a degree to which the pixel corresponds to human skin. A characteristic feature of the skin map is that all pixels of the input image having similar values are mapped to similar respective skin probability values in the skin map. This feature of the skin map is important in, for example, pixels of certain human-skin image patches that have colors outside of the standard human-skin tone range. This may happen, for example, in shaded face-patches or alternatively in face highlights, where skin segments may sometimes have a false boundary between skin and non skin regions. The skin map values vary continuously without artificial boundaries even in skin patches trailing far away from the standard human-skin tone range.

In general, the skin-map module may generate skin probability values indicating the degrees to which the input image pixels correspond to human skin in a wide variety of different ways. In a typical approach, the skin-map module generates the per-pixel human-skin probability values from human-skin tone probability distributions in respective channels of a color space. For example, in some approaches, the skin-map module generates the per-pixel human-skin tone probability values from human-skin tone probability distributions in the CIE LCH color space (i.e., P(skin|L), P(skin|C), and P(skin|H)). These human-skin tone probability distributions are approximated by Gaussian normal distributions (i.e., G(p,μ,εr)) that are obtained from mean μ and standard deviation εr values for each of the p=L, C, and H color channels.

The skin-map module generates a respective skin probability value for each pixel of the input image by converting the input image into the CIE LCH color space, when necessary, determining the respective skin-tone probability value for each of the L, C, and H color channels based on the corresponding human-skin tone probability distributions, and computing the product of the color channel probabilities by:

P(skin|L,C,H)≈G(L,μ_{L},εr_{L})×G(C,μ_{C},εr_{C})×G(H,μ_{H},εr_{H})

In some approaches, the skin map values are computed by applying to the probability function P(skin|L,C,H) a range adaptation function that provides a clearer distinction between skin and non-skin pixels. In some of these approaches, the range adaptation function is a power function of the type:

M_{SKIN}(x,y)=P(skin|L(i),C(i),H(i))^{1/γ}

where γ>0 and M_{SKIN}(x,y) are the skin map 62 values at location (x,y). In one exemplary embodiment, γ=32. The above skin map function attaches high probabilities to a large spectrum of skin tones, while non-skin features typically attain lower probabilities.

### Embodiments of the Present Invention

With the various embodiments of a 3D-boosting method based on the unified scheme for spatial image processing (“USSIP”) having been described, and with various approaches to generating face maps and skin maps from input images having also been described, method and system embodiments of the present invention can now be described. As was discussed above, many globally applied contrast-enhancement techniques inadvertently produce a variety of different anomalies, artifacts, and distortions, in addition to producing various types of desirable image enhancements. As also discussed above, the multi-scale USSIP approach to image processing involves generation of a photographic mask and a temporary image from an input image to facilitate generation of a contrast-enhanced output image. Photographic masks represent an essential soft segmentation of the image, which can be enhanced by certain image-processing techniques, while the temporary image includes details which can be transformed by enhancement methods to produce 3D boosting, sharpening, denoising, and other image enhancements. As discussed above, the transformed temporary image and enhanced photographic mask can be recombined to produce a contrast-enhanced output image, in which segment-by-segment enhancement is carried out to avoid many of the anomalies, aberrations, and distortions produced by contrast-enhancement techniques that are applied globally to an input image, without consideration of the enhancement needs and constraints of different regions or segments within the input image.

While the above-described 3D-boosting methods have proven effective in increasing the perceived depth perception of two-dimensional images, without producing many of the anomalies, distortions, and aberrations encountered when global-contrast enhancement methods are instead applied to images, the 3D-boosting method has been found to be overly effective with regard to enhancement of images containing sub-images of human faces. While enhanced perception of depth is generally highly regarded by human viewers of 3D-boosted images, considering 3D boosting to provide greater depth-related texture and detail and a more life-like view of the scenes and objects captured in images, the enhanced perception of depth in human faces, resulting from contrast enhancement that emphasizes facial features below and above the average depth, in an image, of the surface of a face, can lead to an undesirable and even disturbing visual emphasis on wrinkles, moles, pock marks, facial hair, and other non-uniform aspects of facial features. This undesirable emphasis on image-depth-related facial non-uniformities is particularly evident in images of older people, where wrinkles and sagging skin appear to be exaggerated to human viewers. Similar undesirable emphasis of non-uniformities may occur in images of human hands and other portions of human bodies, such as neck skin. Various psychological studies have shown that, while people, in general, appreciate high levels of detail and texture for surfaces in photographic images, people generally prefer smoothing and contrast removal in those portions of images applying to facial skin and certain regions of body skin, just as faces generally considered to be beautiful are often faces without distinct non-uniformities and representative of average facial shapes and forms.

As discussed above, there are various techniques for preparing face maps and skin maps from input images. Certain of these face maps and skin maps include probability values for each pixel, indicating a probability that the pixel corresponds to a region depicting a human face or human skin within images.

Because the above-described USSIP-based 3D boosting involves soft segmentation of an image, via the photographic mask, it is a feature of the USSIP-based 3D-boosting method, described above, that different contrast-enhancement techniques can be applied to different segments of an image. As discussed above, for example, a greater degree of sharpening, or 3D boosting, may be applied to certain segments of an image than to others, based on the average pixel values within the segments or on other criteria. It is also possible to undertake an opposite type of image processing, on a per-segment basis, which de-emphasizes, rather than enhances, contrast of details within the segments. As discussed, in greater detail below, in various of the above-described 3D-boosting techniques, intermediate-image pixel values are multiplied by coefficients, generally greater than 1.0, in order to effect 3D boosting. An opposite effect, referred to as “3D busting,” can be carried out by multiplying the intermediate pixel values by a constant less than 1. Thus, by simply changing the relative value of one or more multipliers with respect to the value 1.0, used for computing intermediate pixel values during output-image generation, a segment of an image can be either 3D busted or, in other words, the contrast within these segment can be smoothed or de-emphasized, or, alternatively, a segment of an image can be 3D boosted, or, in other words, the contrast within the segment can be emphasized or enhanced. Certain embodiments of the present invention use one or more decision maps, on a pixel-by-pixel or a segment-by-segment basis, to decide whether or not to apply 3D boosting, no contrast enhancement, or 3D busting to pixels or segments. For example, a face map, or a map related to a face map, may be used as a decision map to direct human-face-related regions of the image to be 3D busted and non-face-related regions of the image to be 3D boosted. In general, any type of region may be identified as a type of region that should be 3D boosted, 3D busted, or not enhanced, and embodiments of the present invention detect region types and accordingly apply the desired contrast enhancement, contrast deemphasis, or no change in the contrast.

Availability of face masks and skin masks provides a basis for deciding whether to apply 3D boosting or 3D busting to pixels or segments in the final stages of a general 3D boosting method. Face maps and skin maps provide indications of those segments of an image that correspond to face regions and correspond to human-skin regions of an image, respectively, and, in various alternative embodiments of the present invention, those segments with reasonable high probability of corresponding to a human face, or those segments with reasonably high probability of corresponding either to a human face or human skin, may be subject to 3D busting, rather than 3D boosting, in an overall 3D-boosting contrast-enhancement method.

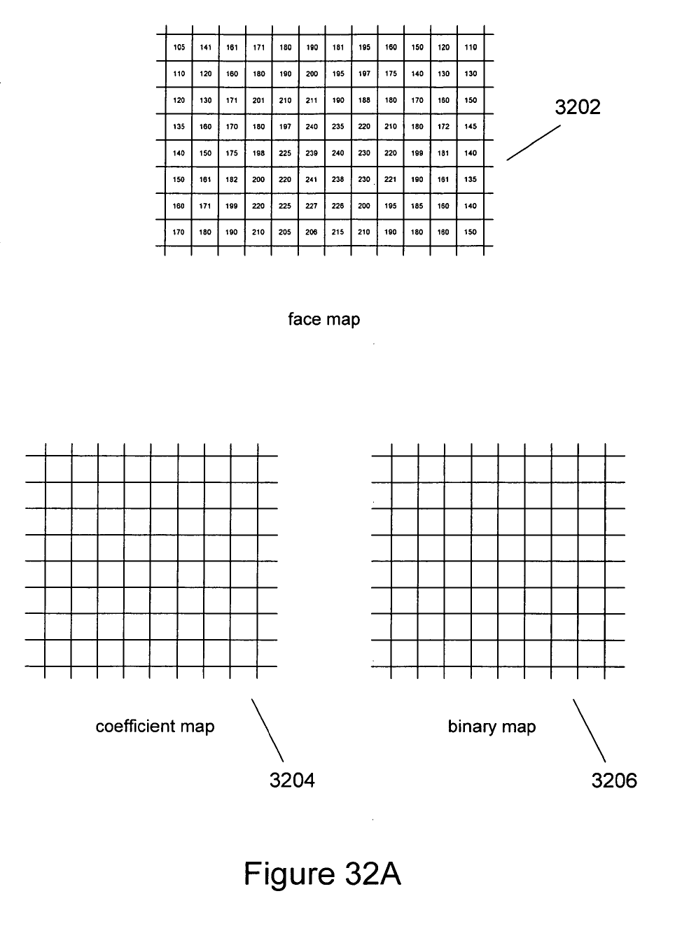

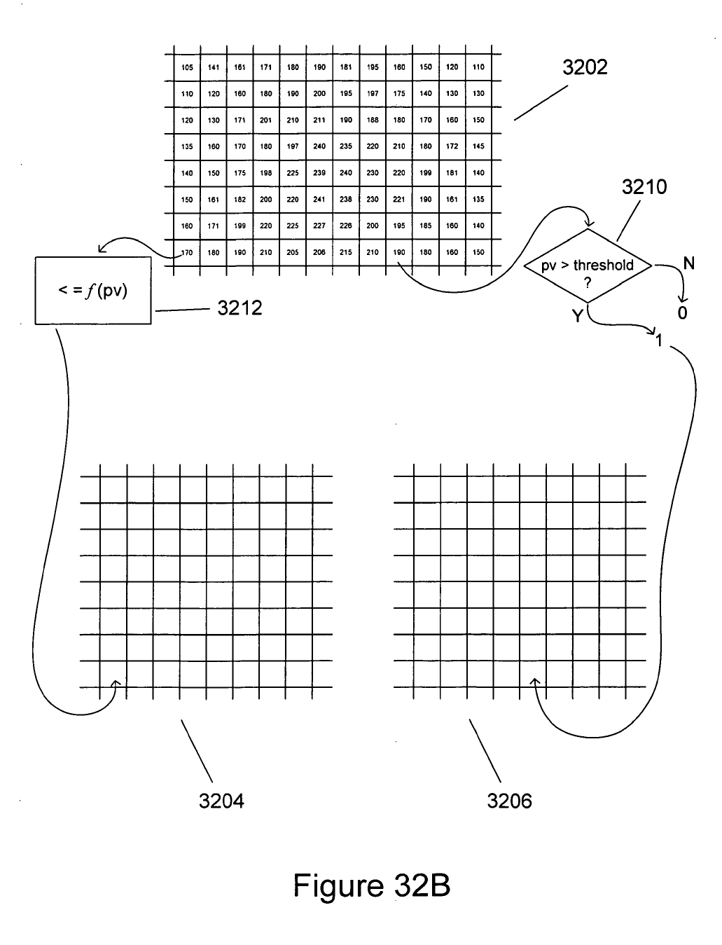

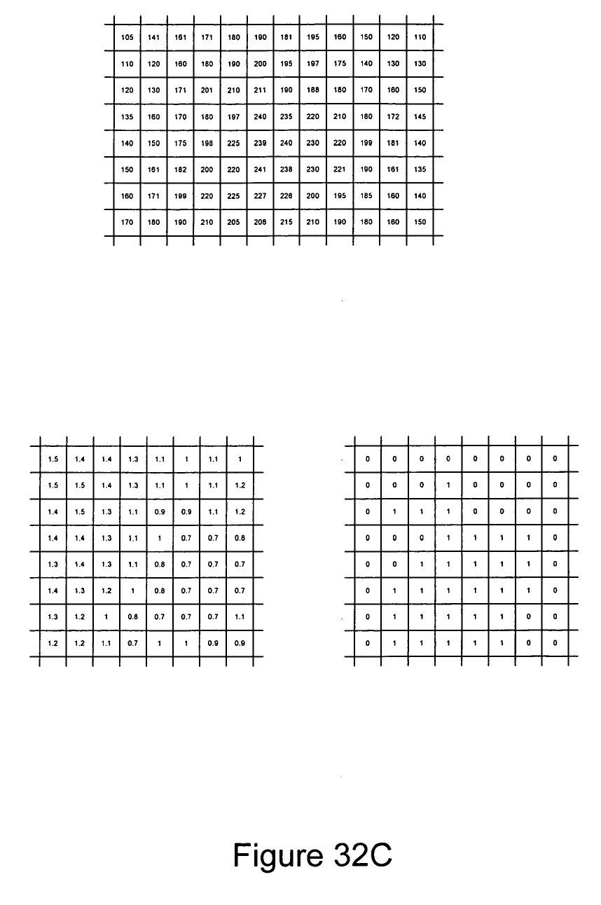

FIGS. 32A-C illustrate two of various different types of ways in which a face map or skin map can be used to generate decision maps that indicate whether or not to apply 3D boosting or 3D busting. In FIG. 32A, a portion of a face map 3202 is shown in the top portion of the figure, with two portions of alternative decision maps derived from the face map, a coefficient map 3204 and a binary map 3206, are shown below the portion of the face map. The coefficient map 3204 and binary map 3206 are but two examples of various different possible decision maps that can be generated according to embodiments of the present invention. In the face map 3202, each cell corresponds to a pixel within the input image, and cell values range from 0 to 255, representing 256 different levels of probability that the corresponding image pixel lies in a face region. Of course, many alternative encodings of ranges of probability values are possible. Face-map cells may alternatively contain floating-point numbers directly representing probabilities between 0.0 and 1.0.

FIG. 32B illustrates how a coefficient map and binary map may be generated from a face map. To generate the binary map 3206, the value in each cell of the face map 3202 is compared to a threshold value 3210. If the face-mask cell value is greater than the threshold value, then the corresponding cell value of the binary map is set to 1, and otherwise is set to 0, as shown in FIG. 32B. This transforms the face mask, which includes probability values, to a binary mask indicating which pixels in the input image belong to face regions and which pixels belong to non-face regions. The binary mask can then be used, during general 3D boosting, to decide whether or not to apply 3D boosting or 3D busting to particular pixels or to particular segments, depending on whether the decision is made at a pixel level or a segment level during image enhancement according to various alternative approaches. By contrast, the coefficient map 3204 is generated by applying a function to each face-mask cell value in order to generate a corresponding coefficient-map cell value 3212. In this fashion, the actual coefficients applied on a pixel-by-pixel basis can be generated from the face mask for use during contrast enhancement. In this case, rather than deciding to apply 3D boosting, 3D busting, or no enhancement, the method need only select the appropriate coefficient from the coefficient map during generation of intermediate pixel values, the selected coefficient value determining whether or not contrast enhancement is applied to a particular pixel, with values greater than 1.0 resulting in 3D boosting and values less than 1.0 resulting in 3D busting. FIG. 32C shows exemplary binary-map values and coefficient-map values generated from the face map.

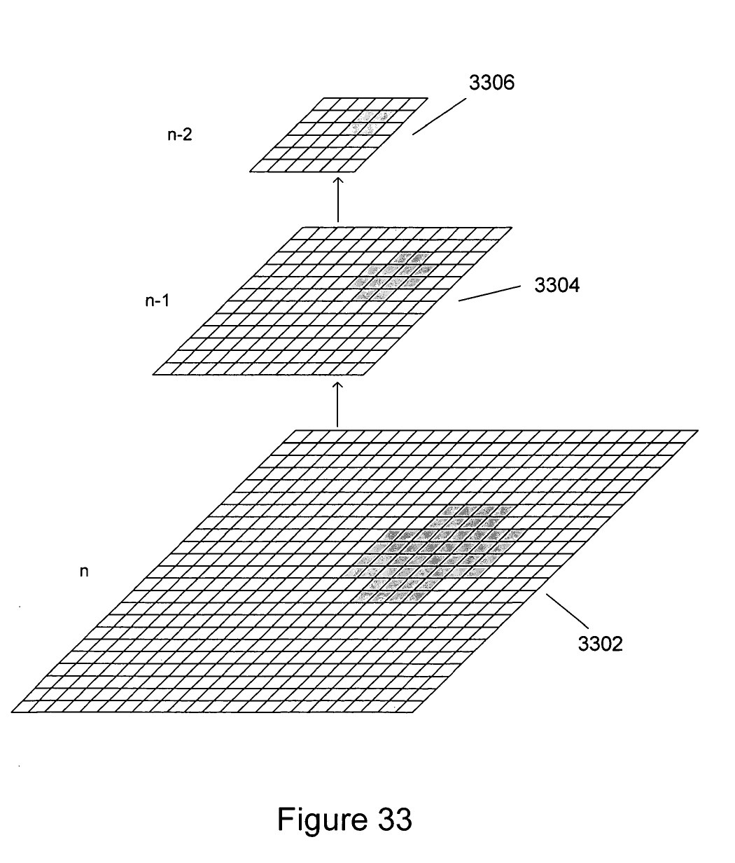

When the choice of coefficients, or choice of applying 3D boosting or 3D busting, occurs at various levels of intermediate images in the USSIP-based contrast-enhancement methods described above, a face map, skin map, binary map, or coefficient map can be appropriately scaled to each of the relevant scaling levels of the intermediate images. FIG. 33 shows scaling of a binary map. The full-size binary map 3302 shows cells with value “1” as shaded and cells with value “0” as unshaded. A downscaling by ½ of the binary map produces a first downscaled binary map 3304, and an additional downscaling by a downscaling factor of ½ produces a second downscaled binary map 3306.

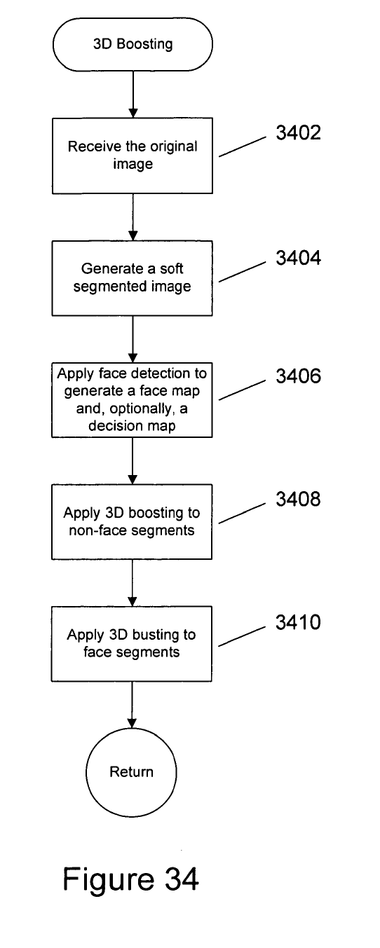

FIG. 34 shows a control-flow diagram for an enhanced 3D-boosting and 3D-busting method that represents one embodiment of the present invention. This control-flow diagram parallels the control-flow diagram provided in FIG. 21. In step 3402, an original image is received. In step 3404, a soft-segment image is produced, by any number of different techniques, three of which are subsequently discussed. In step 3406, a face-mask-generating technique, such as the face-mask-generating method discussed in the previous subsection, is applied to the original image in order to produce a face mask and, optionally, to additionally produce a binary decision map or coefficient map, as discussed above with reference to FIGS. 32A-C. Next, in step 3408, a 3D-boosting method is applied to those pixels, or segments, that do not correspond to human faces, and, in step 3410, a 3D-busting technique is applied to those pixels, or segments, that do correspond to face regions in the original image. In general, steps 3008 and 3410 may be combined, in particular implementations, in a single contrast-enhancement pass through all of the pixels or segments of an intermediate image. As discussed above, the difference between 3D boosting and 3D busting is often simply reflected in whether a multiplier in an intermediate-image pixel-value multiplication is greater than or less than 1.0. A value of 1.0 would produce neither 3D boosting nor 3D busting. In certain embodiments of the present invention, face regions and other such regions may be not enhanced, rather than 3D busted. While FIG. 34 is directed to those embodiments that differentially enhance face regions from other image regions, any type of region that can be identified in an image may be designated as an exception type, to which a different type of processing is applied from other regions. Certain embodiments of the present invention may apply 3D busting to both face regions and body-skin regions, for example.

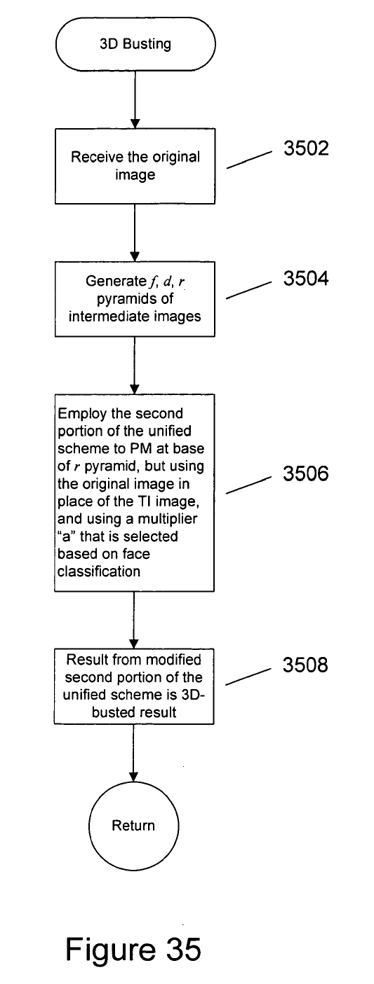

FIG. 35 shows a control-flow diagram for one embodiment of the present invention, which parallels the control-flow diagram provided in FIG. 22. In step 3502, an original image is received. In step 3504, the above-described USSIP image-processing method is employed, in part, to generate low-pass, band-pass, and photographic-mask pyramids in order to then generate the photographic mask P̅M̅. Then, in step 3506, the second portion of the USSIP image-processing method, discussed above with reference to FIG. 10, is carried out, using, in place of the temporary image (904 in FIG. 10), the original image f₀ (810 in FIG. 8A) generated by the pyramid-generation process and also received in step 3502, described above. In addition, the multiplier function “a” (1002 in FIG. 10) is modified to include a final multiplication of the multiplier produced by the multiplier function “a” by a constant that is greater than 1.0 for non-face regions or segments, and that is less than 1.0 for those pixels or regions indicated as corresponding to human face in the image. The constant may be directly selected from a coefficients map, as discussed above with reference to FIGS. 32A-C, or the value determined from either the face map or from the binary map, also discussed above with reference to FIGS. 32A-C. In certain embodiments, it may be sufficient to select a single constant greater than 1.0 for non-face regions and a single constant multiplier less than 1.0 for face regions. Alternatively, the magnitude of the constant may depend on the probability that the pixel or region belongs to a human face portion of an image using the probabilities in the face map or constants derived from those probabilities in the coefficient map. Similar considerations apply to the originally described approach, shown in FIG. 9, above. In that case, a constant multiplier k is used to multiply the value of each pixel in the details map, rather than computing the multiplier by function “a” as described with reference to FIG. 10. In a method of the present invention related to the method illustrated in FIG. 9, the constant k would be selected as greater than 1.0 for pixels in the details image indicated to be non-face regions, and k would be selected to be less than 1.0 for pixels of the details map that are indicated to belong to face regions by either the face map or the binary map discussed with reference to FIGS. 32A-C. Alternatively, the constant k could be directly selected from a coefficients map, also discussed above with reference to FIGS. 32A-C. The result of this process is, as shown in step 3508, an image that is generally 3D boosted, with the exception of those regions of the image corresponding to human face, which are instead 3D busted. Note that, as discussed above, a choice of the multiplying value, either a modified multiplying value produced by the function “a” a modified constant k, or a coefficient selected from the coefficient map, may be applied on a pixel-by-pixel multiplication, as discussed with reference to FIG. 9, or may alternatively be computed on a segment or region basis, as discussed above with reference to FIG. 10. In other words, in the approach shown in FIG. 10, the function “a” may be modified to modify the results of the function depending on whether or not the currently considered segment or region is considered to correspond to human face or to non-human-face portions of an image. In this segment-by-segment approach, discussed with reference to FIG. 10, a determination of whether to apply 3D boosting or 3D busting to a segment or region can be based on the number of pixels within that segment or region identified as belonging to a face region of the image divided by the total number of pixels in the region, using a threshold ratio. In alternative embodiments, a more complex decision may need to be made in order to provide different processing to multiple different types of regions, or no processing at all, for certain region types.

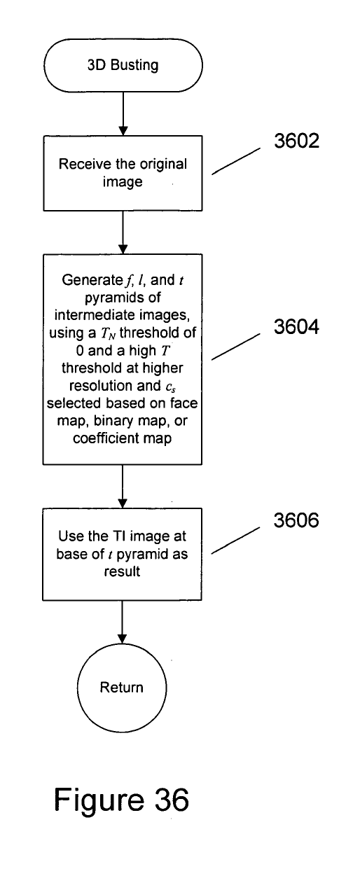

FIG. 36 shows a control-flow diagram for a second embedment of the present invention, which parallels the control-flow diagram provided in FIG. 23. In step 3602, the original image is received. In step 3604, the above-described USSIP image-processing method is used, in part, to generate the low-pass, band-pass, and temporary-image pyramids, with the temporary-image pyramids generated using a T_{N} threshold of 0 and a high T threshold at higher resolutions. Producing the temporary image (“TI”) using these thresholds, the first portion of the USSIP results in the TI being a 3D-boosted transformation of the original image, as noted in step 3606. Note that, however, in the above-described method for computing ψ[l(x,y)] when T_{N}≦|lₛ(x,y)|≦T, the value cₛ is selected to be greater than or equal to 1.0 for those pixels indicated to belong to non-face regions by either the face map or the binary map, described above with reference to FIGS. 32A-C, or as selected directly from the coefficients map, as also described above with reference to FIGS. 32A-C, and selected to be less than 1.0 for those pixels indicated to belong to face regions by the face map or binary map. Additional, but opposite considerations may apply to the constant c_{N}. Again, the intent is to apply 3D boosting to non-face regions of the image and 3D busting to those regions of the image that correspond to human faces. In alternative embodiments, a no-enhancement option may be employed for certain region types by setting cₛ to 1.0.

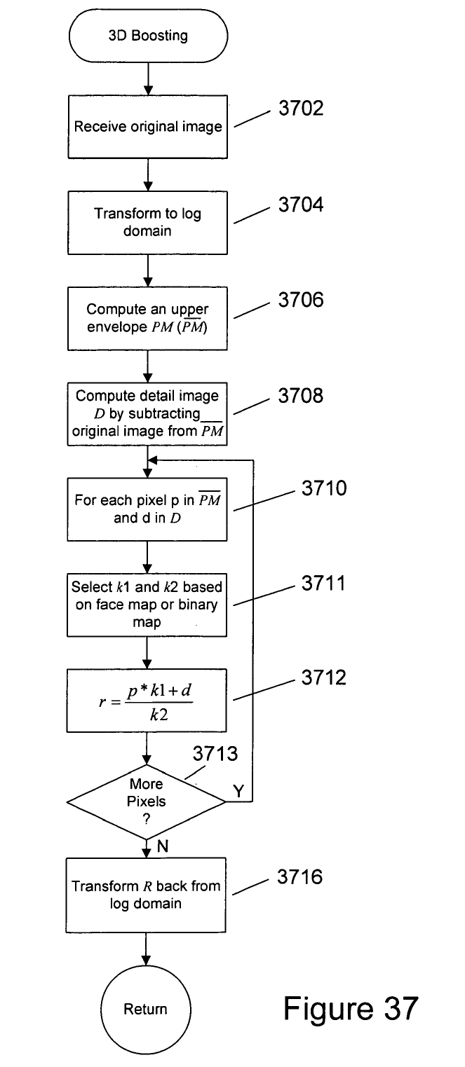

FIG. 37 shows a control-flow diagram for a third embodiment of the present invention, which parallels the control-flow diagram provided in FIG. 24. Steps 3702, 3704, 3706, and 3708 of FIG. 37 are essentially identical to steps 2402, 2404, 2406, and 2408 of FIG. 24, respectively. An input original image is received, in step 3702. Next, in step 3704, the original image is transformed to the log domain by taking the log values of the pixel values in the original image in a pixel-by-pixel fashion. The log values may be taken with respect to an arbitrary base, such as 2, e or 10. Next, in step 3706, an upper envelope photographic mask P̅M̅, is computed using any of various techniques, including the well-known Retinex algorithm discussed in the above-cited references. In step 3708, a detail image D is computed by pixel-by-pixel subtracting the original image from P̅M̅. Steps 3710-3713 together compose a for-loop equivalent to steps 2410-2412 and 2414 of FIG. 24. However, in the embodiment of the present invention described in FIG. 37, a result image R is computed from P̅M̅ and D on a pixel-by-pixel basis. The constants k1 and k2 are selected for each pixel, in step 3711, depending on whether or not the pixel responds to a human-face region or segment in the original image. This determination is made based on the contents of the face map or binary map, as discussed above with reference to FIGS. 32A-C. Alternatively, two coefficient matrixes may be computed, initially, prior to the for-loop in steps 3710-3713 to contain suitable k1 and k2 values. Either the k1, the k2, or both the k1 and k2 values may be modified from those used in FIG. 24 in order to 3D boost non-face regions of the image and 3D bust the human-face regions. In certain embodiments of the present invention, for example, only k2 needs to be modified, with k2 set to a value less than 1.0 for non-human-face pixels and to a value greater than 1.0 for human-face pixels. Each pixel r of the result image R is computed from corresponding pixels in P̅M̅ and D, in step 3712, just as previously described, with reference to FIG. 24, in steps 2410, 2412, and 2414. Finally, in step 3716, the result image R is transformed back from the log domain to the original-image domain by a pixel-by-pixel anti-log operation.

As would be obvious to those familiar with image processing and computer science, the above described methods can be feasibly carried out only by an electronic computer, since images contain many hundreds of thousands to millions of pixels. Furthermore, the processed images are intended to be electronically stored within computer systems or other electronic devices, rendered for display or printing by computer systems or other electronic devices, and transferred among computer systems and other electronic devices.

Although the embodiments of the present invention discussed with reference to FIGS. 34-37 are directed to applying 3D boosting to non-human-face portions of an image and 3D busting to human-face portions of images, alternative embodiments of the present invention may apply 3D busting to both human-face regions of an image as well as to human-skin regions of an image. In addition, undesirable 3D boosting for other types of image regions may be similarly avoided in the case that appropriate maps for those regions can be generated by techniques similar to generation of face maps and skin maps. For example, in pictures used for advertising a cream-based food product meant to be smooth, cream-related portions of the image may be identified in a cream map and subject to 3D busting, rather than 3D boosting, in an overall 3D boost of the image.

Although the present invention has been described in terms of particular embodiments, it is not intended that the invention be limited to these embodiments. Modifications within the spirit of the invention will be apparent to those skilled in the art. For example, any number of different embodiments of the present invention can be obtained through varying various programming parameters, including programming language, control structures, data structures, modular organization, variable names, and other such programming parameters. The method and system embodiments of the present invention can be tailored to specific applications by adjusting a number of different parameters. For example, any number of different embodiments of the present invention can be obtained by using different one-dimensional look-up tables. As another example, a variety of different intermediate-image computations can be employed, using larger windows, different thresholds and thresholding functions, different scalings, and by varying other such parameters. As yet another example, the third embodiment of the present invention can also be carried out in the input-picture domain, rather than the log domain, using multiplication operations in place of addition operations, division operations in place of subtraction operations, and exponential or power operations in place of multiplications and divisions. While many embodiments of the present invention are directed to general, 3D boosting with excepted regions of the image either not boosted or 3D busted, certain alternative embodiments may provide a continuous range of image enhancement varying from general 3D busting with local 3D boosting to the above-described general 3D boosting with local 3D busting.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A signal-processing system comprising:
a processing component; and
a signal-processing routine, stored on a computer-readable medium, that is read from the computer-readable medium and executed by the processing component to enhance an input image to produce an enhanced, 3D-boosted output image by
computing a soft-segmented image from the input image; and
3D boosting only those regions of the input region that do not correspond to an image region of an excepted type to provide, to a viewer of the visually-rendered 3D-boosted output image, a greater perception of depth, due to enhancement of contrast between shaded and illuminated portions of objects and shaded and illuminated objects with respect to the input image to produce an enhanced, 3D-boosted output image.

2. The signal-processing system of claim 1 wherein a decision map is computed for the input image comprising values that each corresponds to an input-image pixel indicating whether or not the input-image pixel is contained within an excepted type of image region.

3. The signal-processing system of claim 1 wherein the excepted types of regions include one or more of:
regions corresponding to images of human faces; and
regions corresponding to images of human skin.

4. The signal-processing system of claim 1 further including:
3D busting those regions of the input region that correspond to excepted types of image regions to provide, to a viewer of the visually-rendered 3D-boosted output image, a lesser perception of depth, due to a decrease in contrast between shaded and illuminated portions of the image within the regions of the input region that correspond to excepted types.

5. The signal-processing system of claim 1 wherein computing a soft-segmented image from the input image and deriving, from the soft-segmented image and the input image, the enhanced, 3D-boosted output image further comprises:
generating, according to a first portion of a unified scheme for spatial image processing, low-pass, band-pass, and photographic-mask intermediate-image pyramids; and
employing a second, look-up-table-based portion of the unified scheme for spatial image processing, substituting the input image for a temporary image used in the second, look-up-table-based portion of the unified scheme for spatial image processing and multiplying, during pixel-by-pixel multiplication of detail-image pixel values, results of a multiplier-generating function “a” by a second multiplier, the second multiplier greater than 1.0 for 3D boosting and less than 1.0 for 3D busting.

6. The signal-processing system of claim 1 wherein computing a soft-segmented image from the input image and deriving, from the soft-segmented image and the input image, the enhanced, 3D-boosted output image further comprises:
generating, according to a unified scheme for spatial image processing, low-pass, band-pass, and temporary-image intermediate-image pyramids, using a T_{N} threshold of 0.0 and a high T threshold at higher-resolution scales to compute the temporary-image intermediate-image pyramid; and
returning, as the enhanced, 3D-boosted output image, the highest-resolution temporary-image intermediate image of the temporary-image intermediate-image pyramid, wherein the temporary-image intermediate images tₛ are computed by a pixel-by-pixel operation involving the next-lowest-scale intermediate temporary image tₛ₊₁, the low-pass intermediate image fₛ, and the band-pass intermediate image lₛ, expressed as
$${t}_{s} = \{ \begin{matrix}{l}_{s} , & s = N \\ RI \{ {t}_{s + 1} , {f}_{s} \} + {l}_{s} [ 1 - ψ ( {l}_{s} ) ] , & s < N\end{matrix}$$
wherein ψ is a function defined as
when |lₛ(x,y)|>T,
ψ[lₛ(x,y)]=lₛ(x,y),
when |lₛ(x,y)|<T_{N}, where T_{N} is a scale-dependent some noise threshold,
ψ[lₛ(x,y)]=c_{N}lₛ(x,y), where c_{N}<1.
when T_{N}≦|lₛ(x,y)|≦T,
ψ[l(x,y)]=min{cₛ(lₛ(x,y)−TN)+c_{N}T_{N},T},
and wherein cₛ is selected to be greater than 1 for 3D boosting and less than 1 for 3D busting.

7. The signal-processing system of claim 1 wherein computing a soft-segmented image from the input image further comprises:
transforming the input image to a log-domain intermediate image using a pixel-by-pixel logarithm operation; and
computing an upper-envelope photographic mask P̅M̅ from the log-domain intermediate image.

8. The signal-processing system of claim 7 wherein the upper-envelope photographic mask P̅M̅ is computed by a Retinex method.

9. The signal-processing system of claim 6 wherein deriving, from the soft-segmented image and the input image, the enhanced, 3D-boosted output image further comprises:
computing a detail image D from the upper-envelope photographic mask P̅M̅ by pixel-by-pixel subtraction the input image from the upper-envelope photographic mask P̅M̅;
computing, by a pixel-by-pixel multiplication of P̅M̅ by a constant k1, a P̅M̅*k1 intermediate image;
computing a P̅M̅*k1+D intermediate image by pixel-by-pixel addition of the detail image D to the P̅M̅*k1 intermediate image;
computing a ( P̅M̅*k1+D)/k2 intermediate image by pixel-by-pixel division of the P̅M̅*k1+D intermediate image by a constant k2; and
transforming the ( P̅M̅*k1+D)/k2 intermediate image by a pixel-by-pixel antilog operation;
wherein the values of the one or more of the constants k1 and k2 are selected, on a pixel-by-pixel basis, based on whether or not the pixel of P̅M̅ and D that is arithmetically modified by k1 and k2 corresponds to a pixel of the input image within a region of an excepted type.

10. A method that enhances an input image to produce an enhanced output image, the method comprising:
computing a soft-segmented image from the input image; and
3D boosting only those regions of the input region that do not correspond to an image region of an excepted type to provide, to a viewer of the visually-rendered 3D-boosted output image, a greater perception of depth, due to enhancement of contrast between shaded and illuminated portions of objects and shaded and illuminated objects with respect to the input image to produce an enhanced, 3D-boosted output image that is stored in a computer-readable memory for subsequent access, display, or transfer.

11. The method of claim 10 further including:
computing a decision map for the input image comprising values that each corresponds to an input-image pixel indicating whether or not the input-image pixel is contained within an excepted type of image region.

12. The method of claim 11 wherein the types of excepted regions include one or more of:
regions corresponding to images of human faces; and
regions corresponding to images of human skin.

13. The method of claim 11 further including:
3D busting those regions of the input region that correspond to excepted types of image regions to provide, to a viewer of the visually-rendered 3D-boosted output image, a lesser perception of depth, due to a decrease in contrast between shaded and illuminated portions of the image within the regions of the input region that correspond to excepted types.

14. The method of claim 13
wherein 3D boosting is achieved by multiplying, on a pixel-by-pixel basis, an intermediate result by a constant greater than 1.0; and
wherein 3D busting is achieved by multiplying, on a pixel-by-pixel basis, an intermediate result by a constant less than 1.0.

15. Computer instructions stored on a computer-readable medium that implement the method of claim 10.
